(19) United States
(12) Patent Application Publication
(10) Pub. No.: US 2020/0260377 A1
(43) Pub. Date: Aug. 13, 2020

(54) METHOD AND APPARATUS FOR APPLYING DYNAMIC SCHEDULING TO REDUCE POWER CONSUMPTION IN NEXT GENERATION COMMUNICATION SYSTEM

(71) Applicant: Samsung Electronics Co., Ltd., Suwon-si (KR)

(72) Inventors: Seungri JIN, Suwon-si (KR); Soenghun KIM, Suwon-si (KR); Sangbum KIM, Suwon-si (KR)

(21) Appl. No.: 16/788,920

(22) Filed: Feb. 12, 2020

(30) Foreign Application Priority Data
Feb. 12, 2019 (KR) 10-2019-0015969

(51) Int. Cl. H04W 52/02; H04W 72/04

(52) U.S. Cl. CPC H04W 52/0216; H04W 72/0446; H04W 72/0413

(57) ABSTRACT

A communication scheme and system for convergence of IoT technology and a 5G or pre-5G communication system, provided to support a higher data transmission rate than a 4G communication system such as LTE. The disclosure may be applied to a smart service (e.g., a smart home, a smart building, a smart city, a smart car or connected car, healthcare, digital education, retail business, a security and security related service, or the like) based on the 5G communication technology and the IoT related technology. A method and apparatus for applying dynamic scheduling in order to reduce power consumption are provided. The method includes determining a preferred state of the terminal, transmitting, to a base station, a first message including information on the preferred state of the terminal, and receiving, from the base station, a second message for transitioning a state of the terminal as a response to the first message.

### CROSS-REFERENCE TO RELATED APPLICATION(S)

This application is based on and claims priority under 35 U.S.C. § 119(a) of a Korean patent application number 10-2019-0015969, filed on Feb. 12, 2019, in the Korean Intellectual Property Office, the disclosure of which is incorporated by reference herein in its entirety.

### BACKGROUND

### 1. Field

The disclosure relates to a user equipment and a base station in a mobile communication system.

### 2. Description of Related Art

In order to meet wireless data traffic demands that have increased after 4^{th} generation (4G) communication system commercialization, efforts to develop an improved 5th generation (5G) communication system or a pre-5G communication system have been made. For this reason, the 5G communication system or the pre-5G communication system is called a beyond 4G network communication system or a post long-term evolution (LTE) system.

In order to achieve a high data transmission rate, an implementation of the 5G communication system in a mm Wave band (for example, 60 GHz band) is being considered. In the 5G communication system, technologies such as beamforming, massive MIMO, Full Dimensional MIMO (FD-MIMO), array antenna, analog beam-forming, and large-scale antenna technologies are being discussed as means to mitigate a propagation path loss in the ultrahigh-frequency band and increase a propagation transmission distance.

Further, the 5G communication system has developed technologies such as an evolved small cell, an advanced small cell, a cloud Radio Access Network (RAN), an ultra-dense network, Device to Device communication (D2D), a wireless backhaul, a moving network, cooperative communication, Coordinated Multi-Points (CoMP), and received interference cancellation to improve the system network. In addition, the 5G system has developed Advanced Coding Modulation (ACM) schemes such as Hybrid frequency-shift keying (FSK) and Quadrature Amplitude Modulation (QAM) Frequency and QAM (FQAM) and Sliding Window Superposition Coding (SWSC), and advanced access technologies such as Filter Bank Multi Carrier (FBMC), Non Orthogonal Multiple Access (NOMA), and Sparse Code Multiple Access (SCMA).

In a 5G system, supporting of more various services is being considered compared to the 4G system of the related art. For example, most representative services may be a ultra-wide band mobile communication service (enhanced mobile broad band (eMBB)), a ultra-reliable and low latency communication service (ultra-reliable and low latency communication (URLLC)), a massive device-to-device communication service (massive machine type communication (mMTC)), and a next-generation broadcast service (evolved multimedia broadcast/multicast service (eMBMS)). A system providing the URLLC service may be referred to as a URLLC system, and a system providing the eMBB service may be referred to as an eMBB system. The terms “service” and “system” may be interchangeably used.

Among these services, the URLLC service that is a new service under consideration in the 5G system in contrast to the existing 4G system requires to meet ultrahigh reliability (e.g., packet error rate of about 10-5) and low latency (e.g., about 0.5 msec) conditions as compared to the other services. To meet these strict conditions required therefor, the URLLC service may need to apply a shorter transmission time interval (TTI) than the eMBB service, and various operating scheme employing the same are now under consideration.

Meanwhile, the Internet has been evolved to an Internet of Things (IoT) network in which distributed components such as objects exchange and process information from a human-oriented connection network in which humans generate and consume information. An Internet of Everything (IoE) technology in which a big data processing technology through a connection with a cloud server or the like is combined with the IoT technology has emerged. In order to implement IoT, technical factors such as a sensing technique, wired/wireless communication, network infrastructure, service-interface technology, and security technology are required, and research on technologies such as a sensor network, Machine-to-Machine (M2M) communication, Machine-Type Communication (MTC), and the like, for connection between objects has recently been conducted. In an IoT environment, through collection and analysis of data generated in connected objects, an intelligent Internet Technology (IT) service to create a new value for peoples' lives may be provided. The IoT may be applied to fields such as those of a smart home, a smart building, a smart city, a smart car, a connected car, a smart grid, health care, a smart home appliance, or high-tech medical services through the convergence of the Information Technology (IT) of the related art and various industries.

Accordingly, various attempts to apply the 5G communication to the IoT network are made. For example, the 5G communication technology, such as a sensor network, machine-to-machine (M2M) communication, and machine-type communication (MTC), has been implemented by a technique, such as beamforming, MIMO, and array antennas. The application of a cloud RAN as the big data processing technology may be an example of convergence of the 5G technology and the IoT technology.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods for reducing the amount of power consumed by a user equipment (UE) in an NR system. A delay time or a processing time that a UE allows is different depending on the type of communication service provided by the UE. Based on the above-mentioned fact, an uplink scheduling delay may be differently set for the UE, and a period for discontinuous reception in a connected state may be differently set.

In addition, the UE is most aware of the type of traffic incurred by the UE, and thus the UE may determine the possibility of subsequent data transmission/reception, and may suggest a subsequent state of the UE.

The technical subjects pursued in the disclosure may not be limited to the above mentioned technical subjects, and other technical subjects which are not mentioned may be clearly understood, through the following descriptions, by those skilled in the art of the disclosure.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes determining a preferred state of the terminal, transmitting, to a base station, a first message including information on the preferred state of the terminal, and receiving, from the base station, a second message for transitioning a state of the terminal as a response to the first message.

In accordance with another aspect of the disclosure, transmitting the first message includes receiving, from the base station, a configuration information indicating whether the terminal is configured to transmit the information on the preferred state of the terminal to the base station, and transmitting, to a base station, the first message including the information on the preferred state of the terminal, in case that the terminal is configured to transmit the information on the preferred state of the terminal to the base station.

In an embodiment, the first message includes a user equipment (UE) assistance information message.

In an embodiment, the preferred state includes at least one of an idle state, or an inactive state.

In an embodiment, the first message including the information on the preferred state of the terminal is transmitted in case that the terminal does not expect to transmit or receive data within a predetermined time.

In accordance with another aspect of the disclosure, a method performed by a base station in a wireless communication system is provided. The method includes receiving, from a terminal, a first message including information on the preferred state of the terminal and transmitting, to the terminal, a second message for transitioning a state of the terminal as a response to the first message.

In accordance with another aspect of the disclosure, receiving the first message includes transmitting, to the terminal, a configuration information indicating whether the terminal is configured to transmit the information on the preferred state of the terminal to the base station, and receiving, from the terminal, the first message including the information on the preferred state of the terminal, in case that the terminal is configured to transmit the information on the preferred state of the terminal to the base station.

In an embodiment, the first message includes a user equipment (UE) assistance information message.

In an embodiment, the preferred state includes at least one of an idle state, or an inactive state.

In an embodiment, wherein the first message including the information on the preferred state of the terminal is received in case that the terminal does not expect to transmit or receive data within a predetermined time.

In accordance with another aspect of the disclosure, a terminal in a wireless communication system is provided. The terminal includes a transceiver and a controller configured to determine a preferred state of the terminal, transmit, to a base station via the transceiver, a first message including information on the preferred state of the terminal, and receive, from the base station via the transceiver, a second message for transitioning a state of the terminal as a response to the first message.

In accordance with another aspect of the disclosure, a terminal in a wireless communication system is provided. The terminal includes a transceiver and a controller configured to receive, from a terminal via the transceiver, a first message including information on the preferred state of the terminal, and transmit, to the terminal via the transceiver, a second message for transitioning a state of the terminal as a response to the first message.

According to the UE operation provided in the disclosure, a UE can differently apply an internal operation associated with uplink scheduling with respect to a predetermined traffic, whereby a period of discontinuous reception is changed and UE power consumption can be reduced.

In addition, according to an embodiment of the disclosure, a UE can predict a predetermined traffic and suggest a UE state for the situation when a radio resource control (RRC) Release message is received, and thus, the UE can perform transition to an appropriate UE state, whereby a quick transition to a connected state is allowed and the UE's power consumption can be reduced.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a structure of a long-term evolution (LTE) system according to an embodiment of the disclosure;

FIG. 2 is a diagram illustrating a structure of a radio protocol in an LTE system according to an embodiment of the disclosure;

FIG. 3 is a diagram illustrating a structure of a next generation mobile communication system according to an embodiment of the disclosure;

FIG. 4 is a diagram illustrating a structure of a radio protocol of a next generation mobile communication system according to an embodiment of the disclosure;

FIG. 5 is a diagram illustrating a discontinuous reception (DRX) operation according to an embodiment of the disclosure;

FIG. 6 is a diagram illustrating a characteristic and effect of a user equipment (UE) operation according to an embodiment of the disclosure;

FIG. 7 is a diagram illustrating an overall operation in which an operation related to a UE request delay report and condensed scheduling are performed according to an embodiment of the disclosure;

FIG. 8 is a diagram illustrating the overall UE operation in which an operation related to a UE request delay report and condensed scheduling are performed according to an embodiment of the disclosure;

FIG. 9 is a diagram illustrating an overall base station operation in which an operation related to a UE request delay report and condensed scheduling are performed according to an embodiment of the disclosure;

FIG. 10 is a diagram illustrating an overall UE operation that requests a state to which a UE is to perform transition when a data inactivity timer expires, according to an embodiment of the disclosure;

FIG. 11 is a diagram illustrating an overall base station operation that requests a state to which a UE is to perform transition when a data inactivity timer expires, according to an embodiment of the disclosure;

FIG. 12 is a diagram illustrating an overall procedure in which a UE in a connected state performs transition to a radio resource control (RRC) inactive mode according to a request of the UE if a data inactivity timer expires, according to an embodiment of the disclosure;

FIG. 13 is a diagram illustrating an overall procedure in which a UE in a connected state performs transition to an RRC idle mode according to a request of the UE if a data inactivity timer expires, according to an embodiment of the disclosure;

FIG. 14 is a block diagram illustrating the internal structure of a UE according to an embodiment of the disclosure; and

FIG. 15 is a block diagram of the configuration of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

For convenience of description, the disclosure uses terms and names defined in a 3rd Generation Partnership Project Long Term Evolution (3GPP LTE). However, the disclosure is not limited by the terms and names, and may be equally applied to a system that is based on another standard.

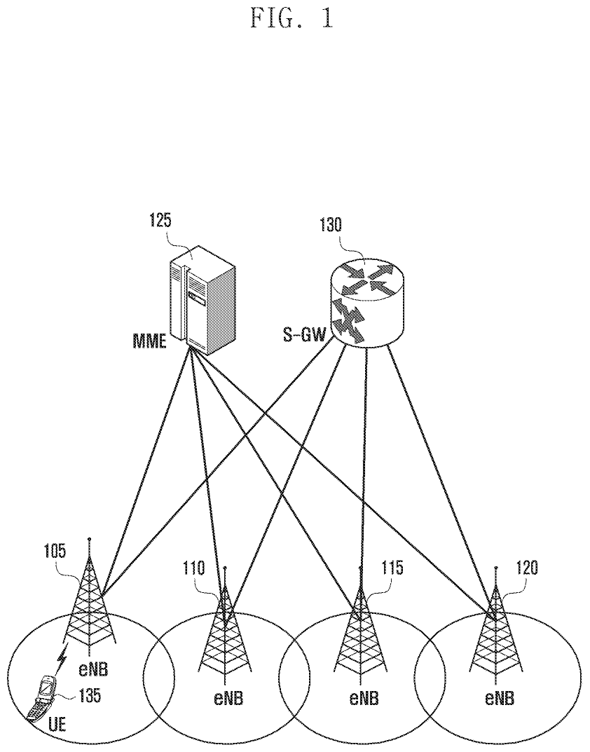

FIG. 1 is a diagram illustrating a structure of an LTE system according to an embodiment of the disclosure.

Referring to FIG. 1, in the drawings, a radio access network of an LTE system includes a next generation base station (an evolved Node B (eNB), a Node B, or a base station) 105, 110, 115, and 120, a mobility management entity (MME) 125, and a serving-gateway (S-GW) 130. A user equipment (UE) (or a terminal) 135 accesses an external network via the eNB 105 to 120 and the S-GW 130.

In FIG. 1, the eNB 105 to 120 corresponds to an existing node B in a UMTS system. The eNB 105 to 120 is connected to the UE 135 via a radio channel and performs a more complex function in comparison with an existing node B. In the LTE system, real-time services, such as a voice over internet protocol IP (VoIP) via an Internet protocol, and all user traffic are provided via a shared channel Accordingly, there is a desire for a device that performs scheduling by collecting state information, such as a buffer state, an available transmission power state, a channel state, and the like in association with the UEs 135, and the eNB 105 to 120 is in charge of the same. One eNB 105 to 120 generally controls a plurality of cells. For example, in order to implement a transmission rate of 100 Mbps, the LTE system uses an orthogonal frequency division multiplexing (OFDM) as a wireless access technology in a bandwidth of 20 MHz. Further, the LTE system uses an adaptive modulation and coding (AMC) scheme that determines a modulation scheme and a channel coding rate according to the channel state of the UE 135. The S-GW 130 is a device for providing a data bearer, and generates or removes the data bearer according to control of the MME 125. The MME 125 is a device that is in charge of various control functions in addition to a mobility management function associated with the UE 135, and may be connected to a plurality of eNBs 105 to 120.

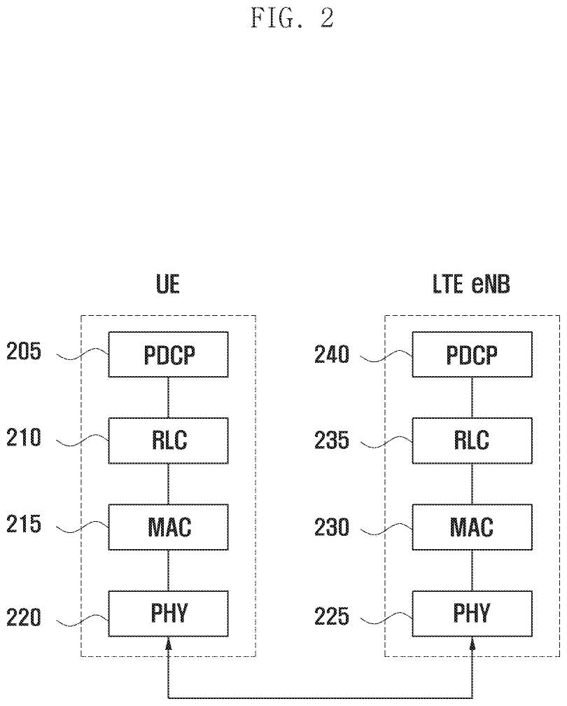

FIG. 2 is a diagram illustrating a structure of a radio protocol in an LTE system according to an embodiment of the disclosure.

Referring to FIG. 2, the radio protocol of the LTE system may include a packet data convergence protocol (PDCP) 205 and 240, a radio link control (RLC) 210 and 235, a medium access control (MAC) 215 and 230 for a UE and an eNB, respectively. The PDCP 205 and 240 is in charge of IP header compression/decompression. The main functions of the PDCP 205 and 240 are summarized as follows:
header compression and decompression (header compression and decompression: ROHC only)
transfer of user data
sequential delivery (in-sequence delivery of upper layer packet data unit (PDUs) at PDCP re-establishment procedure for RLC AM)
reordering (for split bearers in DC (only support for RLC AM): PDCP PDU routing for transmission and PDCP PDU reordering for reception)
duplicate detection (duplicate detection of lower layer SDUs at PDCP re-establishment procedure for RLC AM)
retransmission (retransmission of PDCP SDUs at handover and, for split bearers in DC, of PDCP PDUs at PDCP data-recovery procedure, for RLC AM)
ciphering and deciphering
timer-based SDU discard (timer-based SDU discard in uplink)

The radio link control (RLC) 210 and 235 reestablishes a PDCP packet data unit (PDU) in an appropriate size, and performs automatic repeat query (ARQ) or the like. The main functions of the RLC 210 and 235 are summarized as follows.
transfer of data (transfer of upper layer PDUs)
ARQ (error correction via ARQ (only for AM data transfer))
concatenation, segmentation and reassembly (concatenation, segmentation and reassembly of RLC SDUs (only for UM and AM data transfer))
re-segmentation (re-segmentation of RLC data PDUs (only for AM data transfer))
reordering (reordering of RLC data PDUs (only for UM and AM data transfer)
duplicate detection (duplicate detection (only for UM and AM data transfer))
error detection (protocol error detection (only for AM data transfer))
RLC SDU discard (RLC SDU discard (only for UM and AM data transfer))
RLC reestablishment

The MAC 215 and 230 is connected with various RLC layer devices configured for one UE, and multiplexes RLC PDUs to a MAC PDU and de-multiplexes RLC PDUs from a MAC PDU. The main functions of the MAC 215 and 230 are summarized as follows:
mapping (mapping between logical channels and transport channels)
multiplexing and demultiplexing (multiplexing/demultiplexing of MAC SDUs belonging to one or different logical channels into/from transport blocks (TB) delivered to/from the physical layer on transport channels)
scheduling information reporting
HARQ (error correcting via HARQ)
priority handling between logical channels (priority handling between logical channels of one UE)
priority handling between UEs (priority handling between UEs by means of dynamic scheduling)
MBMS service identification
transport format selection
padding

The physical (PHY) layer 220 and 225 performs channel-coding and modulating of upper layer data to generate an OFDM symbol, and transmits the OFDM symbol via a wireless channel, or performs demodulating and channel-decoding of an OFDM symbol received via a wireless channel and transmits the demodulated and channel-decoded OFDM symbol to an upper layer. Also, in the physical layer, in order to perform additional error correction, hybrid ARQ (HARQ) is used. A reception end transmits one bit indicating whether a packet transmitted from a transmission end is received. This is referred to as HARQ ACK/NACK information. Downlink HARQ ACK/NACK information associated with uplink transmission may be transmitted via a physical hybrid-ARQ indicator channel (PHICH). Uplink HARQ ACK/NACK information associated with downlink transmission may be transmitted via a physical uplink control channel (PUCCH) or a physical uplink shared channel (PUSCH).

The PHY layer 220 and 225 may include one or more frequencies/carriers. A technology that simultaneously configures a plurality of frequencies to use is referred to as carrier aggregation (CA). CA is a technology that uses one or more subcarriers in addition to a main carrier so as to dramatically increase the amount of transmission in proportion to the number of the subcarriers, compared to the scheme of the related art that uses only a single carrier for communication between a user equipment (UE) and an E-UTRAN NodeB (eNB). In LTE, a cell in a base station that uses a main carrier is referred to as a primary cell (PCell) and a sub-carrier is referred to as a secondary cell (SCell).

Although not illustrated in the drawings, a radio resource control (RRC) layer exists above the PDCP layer 205 and 240 of each of the UE and the eNB. In the RRC layer, configuration control messages related to access and measurement may be transmitted or received for radio resource control.

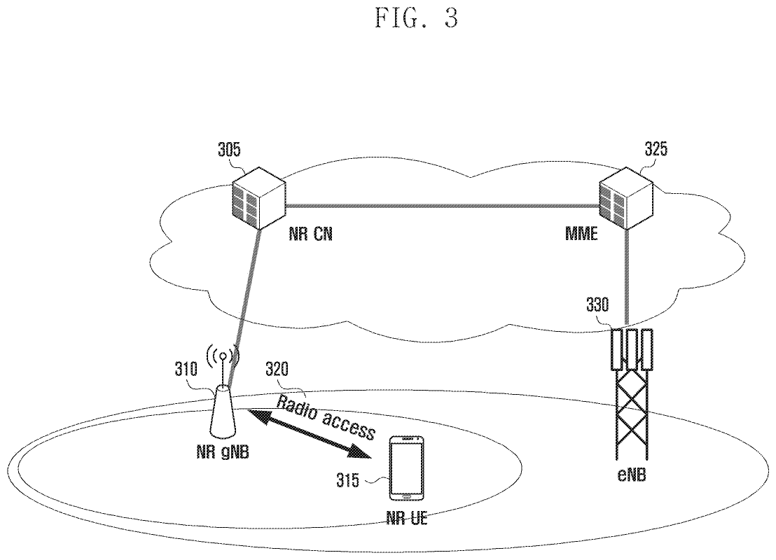

FIG. 3 is a diagram illustrating a structure of a next generation mobile communication system according to an embodiment of the disclosure.

Referring to FIG. 3, a radio access network of a next generation mobile communication system includes a next radio node B (NR NB) (or a gNB) 310 and a new radio core network (NR CN) (or a next generation core network (NG CN)) 305 as illustrated in the drawing. A new radio user equipment (NR UE) (or a UE) 315 may access an external network via an NR NB 310 and an NR CN 305.

In FIG. 3, the NR NB 310 corresponds to an evolved nodeB (eNB) of an legacy LTE system. The NR NB is connected to the NR UE 315 via a wireless channel, and may provide a better service than a service provided from an existing nodeB. In the next generation mobile communication system, all user traffic are serviced via a shared channel. Accordingly, there is a desire for a device that performs scheduling by collecting state information such as a buffer state, an available transmission power state, a channel condition, and the like in association with UEs 315. The NR NB 310 takes charge of the same. A single NR NB generally controls a plurality of cells. In order to implement ultra-high speed data transmission when compared to the legacy LTE, the next generation mobile communication system may have a bandwidth greater than or equal to the current maximum bandwidth, and may additionally use a beamforming technology by using an orthogonal frequency division multiplexing (OFDM) as a radio access technology. Further, the next generation mobile communication system uses an adaptive modulation and coding (hereinafter, referred to as AMC) scheme that determines a modulation scheme and a channel coding rate according to the channel state of the UE 315. The NR CN 305 performs a function of supporting mobility, configuring a bearer, configuring a QoS, and the like. The NR CN 305 is a device that is in charge of various control functions in addition to a mobility management function associated with the UE 315, and may be connected (e.g., radio access 320) to a plurality of NR NBs 310. Also, the next generation mobile communication system may interoperate with a legacy LTE system, and the NR CN 305 is connected to the MME 325 via a network interface. The MME 325 is connected to the eNB 330 which is a legacy eNB.

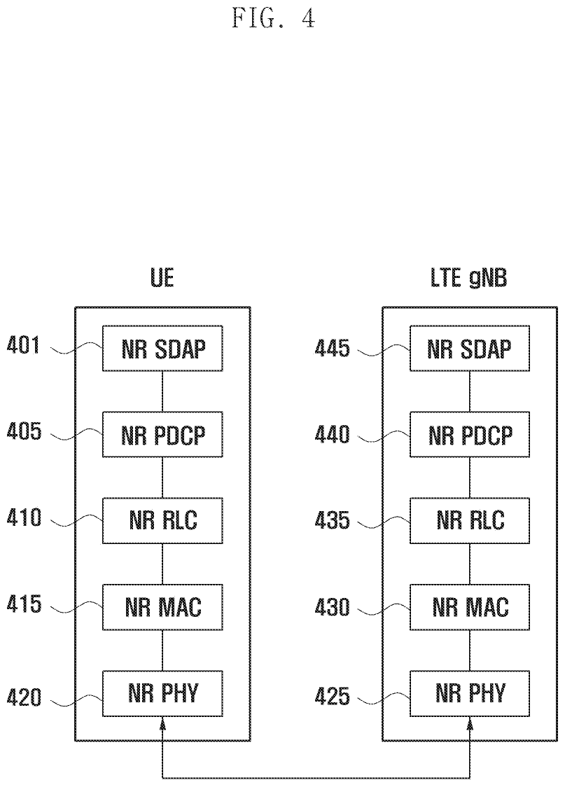

FIG. 4 is a diagram illustrating a structure of a radio protocol of a next generation mobile communication system according to an embodiment of the disclosure.

Referring to FIG. 4, the radio protocol of the network generation mobile communication system may include a service data adaptation protocol (NR SDAP) 401 and 445, an NR PDCP 405 and 440, an NR RLC 410 and 435, and an NR MAC 415 and 430, for a UE and an NR gNB, respectively.

The main functions of the NR SDAP 401 and 445 may include some of the following functions:
transfer of user data (transfer or user plane data)
mapping between a QoS flow and a data bearer (DRB) for both a downlink (DL) and an uplink (UL)
marking a QoS flow ID in both DL and UL packets)
reflective QoS flow to DRB mapping for uplink SDAP PDUs

In association with the SDAP 401 layer device, whether to use the header of the NR SDAP 401 layer device or whether to use the function of the NR SDAP 401 layer device may be configured for the UE via an RRC message for each NR PDCP 405 layer device, for each bearer, or for each logical channel If the SDAP header is configured, a NAS reflective QoS configuration one-bit indicator and an AS reflective QoS configuration one-bit indicator of the SDAP header may provide an indication so that the UE updates or reconfigures mapping information between a QoS flow and a data bearer in an uplink and a downlink. The SDAP header may include QoS flow ID information indicating QoS. The QoS information may be used as data processing priority information, scheduling information, or the like for supporting a smooth service.

The main functions of the NR PDCP 405 and 440 may include some of the following functions:
header compression and decompression (header compression and decompression: ROHC only)
transfer of user data
sequential transfer (in-sequence delivery of upper layer PDUs)
non-sequential transfer (out-of sequence delivery of upper layer PDUs)
reordering (PDCP PDU reordering for reception)
duplicate detection (duplicate detection of lower layer SDUs)
retransmission (retransmission of PDCP SDUs)
ciphering and deciphering
timer-based SDU discard (timer-based SDU discard in uplink)

The mentioned reordering function of the NR PDCP device 405 and 440 is a function of sequentially reordering PDCP PDUs received from a lower layer according to a sequence number. The reordering function may include a function of transferring sequentially reordered data to an upper layer, a function of immediately transferring data irrespective of a sequence, a function of recording lost PDCP PDUs after sequential recording, a function of reporting the states of lost PDCP PDUs to a transmission side, and a function of requesting retransmission of lost PDCP PDUs.

The main functions of the NR RLC 410 and 435 may include some of the following functions:
transfer of data (transfer of upper layer PDUs)
sequential transfer (in-sequence delivery of upper layer PDUs)
non-sequential transfer (out-of sequence delivery of upper layer PDUs)
ARQ (error correcting via ARQ)
concatenation, segmentation, and reassembly (concatenation, segmentation and reassembly of RLC SDUs)
re-segmentation (re-segmentation of RLC data PDUs)
reordering (reordering of RLC data PDUs)
duplicate detection
error detection (protocol error detection)
RLC SDU discard
RLC re-establishment

The mentioned in-sequence delivery function of the NR RLC device 410 and 435 is a function of sequentially transferring RLC SDUs, received from a lower layer, to an upper layer. If a single original RLC SDU is divided into multiple RLC SDUs and the multiple RLC SDUs are received, the in-sequence delivery function may include a function of re-establishing and transferring the same. The in-sequence delivery function may include a function of reordering received RLC PDUs according to an RLC sequence number (SN) or a PDCP SN, and a function of recording lost RLC PDUs after sequential reordering. Also, the in-sequence delivery function may include a function of reporting the states of lost RLC PDUs to a transmission side and a function of requesting retransmission of lost RLC PDUs. The in-sequence delivery function may include a function of sequentially transferring only RLC SDUs before a lost RLC SDU, to an upper layer, if a lost RLC SDU exists. The in-sequence delivery function may include a function of sequentially transferring RLC SDUs, received before a predetermined timer starts, to an upper layer even though a lost RLC SDU exists, if the predetermined timer expires. Alternatively, the in-sequence delivery function may include a function of sequentially transferring RLC SDUs, received up to the present, to an upper layer even though a lost RLC SDU exists, if a predetermined timer expires. Also, RLC PDUs are processed in order of reception (in order or arrival, irrespective of a sequence number), and are transmitted to the NR PDCP device 405 and 440 irrespective of a sequence (out-of sequence delivery). In the case of segments, segments, which are stored in a buffer or which are to be received in the future, are received and reconfigured as a single intact RLC PDU, and are processed and transmitted to the NR PDCP 405 and 440 devices. The NR RLC 410 and 435 layers may not include a concatenation function. Also, the concatenation function may be performed in the NR MAC 415 and 430 layers or may be replaced with a multiplexing function in the NR MAC 415 and 430 layers.

The above-mentioned out-of-sequence delivery function of the NR RLC 410 and 435 devices is a function of transferring RLC SDUs, received from a lower layer, to an upper layer irrespective of a sequence. In the case in which a single original RLC SDU is divided into multiple RLC SDUs and the multiple RLC SDUs are received, the out-of-sequence delivery function may include a function of re-establishing and transmitting the same, and a function of storing the RLC SN or PDCP SN of received RLC PDUs and recording lost RLC PDUs after sequential ordering.

The NR MAC 415 and 430 may be connected to multiple NR RLC layer devices configured for a single UE. The main functions of the NR MAC 415 and 430 may include some of the following functions:
mapping (mapping between logical channels and transport channels)
multiplexing and demultiplexing (multiplexing/demultiplexing of MAC SDUs)
scheduling information reporting
HARQ (error correcting via HARQ)
priority handling between logical channels (priority handling between logical channels of one UE)
priority handling between UEs (priority handling between UEs by means of dynamic scheduling)
MBMS service identification
transport format selection
padding

The NR PHY layer 420 and 425 performs channel-coding and modulating of upper layer data to generate an OFDM symbol and transmits the OFDM symbol via a wireless channel, or performs demodulating and channel-decoding of the OFDM symbol, received via a wireless channel, and transmits the demodulated and channel-decoded OFDM symbol to an upper layer.

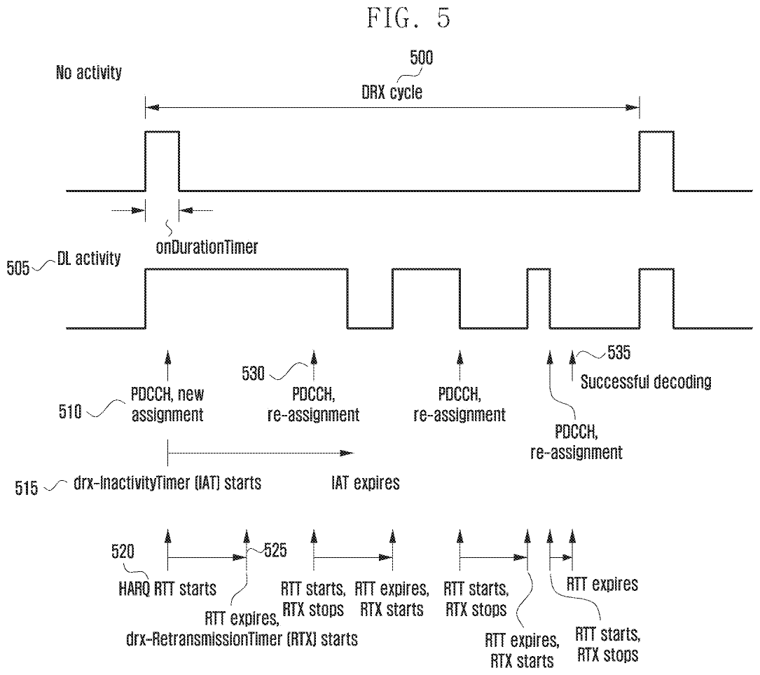

FIG. 5 is a diagram illustrating a DRX operation according to an embodiment of the disclosure.

Referring to FIG. 5, discontinuous reception (DRX) is applied in order to minimize the amount of power consumed by a UE, and is a technology of performing monitoring only in a predetermined physical downlink control channel (PDCCH) in order to obtain scheduling information. DRX may operate in both an idle mode and a connected mode, and the operation methods thereof are slightly different from each other. The disclosure is related to the connected mode. When a UE continuously monitors a PDCCH in order to obtain scheduling information, the UE may consume a large amount of power. A basic DRX operation has a DRX cycle 500, and a UE may monitor a PDCCH only during an on-duration 505. In the connected mode, two values, that is, a long DRX and a short DRX, may be configured as the DRX cycle 500. Generally, a long DRX cycle may be applied. As needed, a base station may trigger a short DRX cycle configured for a UE using a MAC control element (MAC CE). After a predetermined period of time elapses, the UE changes the short DRX cycle to the long DRX cycle. The initial scheduling information of a predetermined UE may be provided in only the predetermined PDCCH. Therefore, the UE periodically monitors only the PDCCH, and may minimize power consumption. During the on-duration 505, if scheduling information associated with a new packet is received via a PDCCH in operation 510, the UE may start a DRX inactivity timer 515. The UE maintains an active state while the DRX inactivity timer 515 operates. That is, the UE continues PDCCH monitoring while the DRX inactivity timer 515 operates. Also, the UE starts a HARQ round trip time (RTT) timer 520. The HARQ RTT timer 520 is applied in order to prevent the UE from unnecessarily monitoring a PDCCH during a HARQ RTT. While the HARQ RTT timer 520 operates, the UE may not need to perform PDCCH monitoring. However, if the DRX inactivity timer 515 and the HARQ RTT timer 520 operate simultaneously, the UE continues PDCCH monitoring based on the DRX inactivity timer 515. If the HARQ RTT timer 520 expires, a DRX retransmission timer 525 starts. While the DRX retransmission timer 525 operates, the UE needs to perform PDCCH monitoring. Generally, while the DRX retransmission timer 525 operates, scheduling information for HARQ retransmission is received in operation 530. If the UE receives the scheduling information, the UE immediately stops the DRX retransmission timer 525, and starts the HARQ RTT timer 520 again. The above-described operation is continued until the UE successfully receives the packet in operation 535.

Configuration information related to the DRX operation in the connected mode may be transferred to the UE via an RRCReconfiguration message. In the LTE system, an on-duration timer, a DRX inactivity timer, and a DRX retransmission timer are defined by the number of PDCCH subframes. In the NR system, they are defined by an absolute time (ms). If predetermined subframes or a predetermined period of time elapses after a timer starts, the timer expires. For reference, in frequency division duplex (FDD) of the LTE system, all downlink subframes are PDCCH subframes. In time division duplex (TDD) of the LTE system, downlink subframes and special subframes are PDCCH subframes. In TDD of the system, a downlink subframe, an uplink subframe, and a special subframe may exist in the same frequency band. Among them, a downlink subframe and a special subframe may be considered as PDCCH subframes. In the NR system, an absolute time is used, and thus, a timer may be applied in a simple manner.

As described above, a base station may configure two states such as long DRX and short DRX. The base station may use one of the two states by taking into consideration power preference indication information and UE mobility recording information, reported by a UE, and the characteristic of a configured DRB. State transition between two states may be performed based on whether a predetermined timer expires or may be performed by transmitting a predetermined MAC CE to the UE. In the legacy LTE, only two DRX cycles may be configured. Accordingly, a DRX cycle may not be dynamically changed according to various DRB characteristics, traffic patterns, buffer states, or the like.

Embodiment 1 of the disclosure provides a DRX operation that is capable of dynamically changing a DRX cycle or drx-InactivityTimer according to various DRX characteristics, traffic patterns, buffer states, and the like.

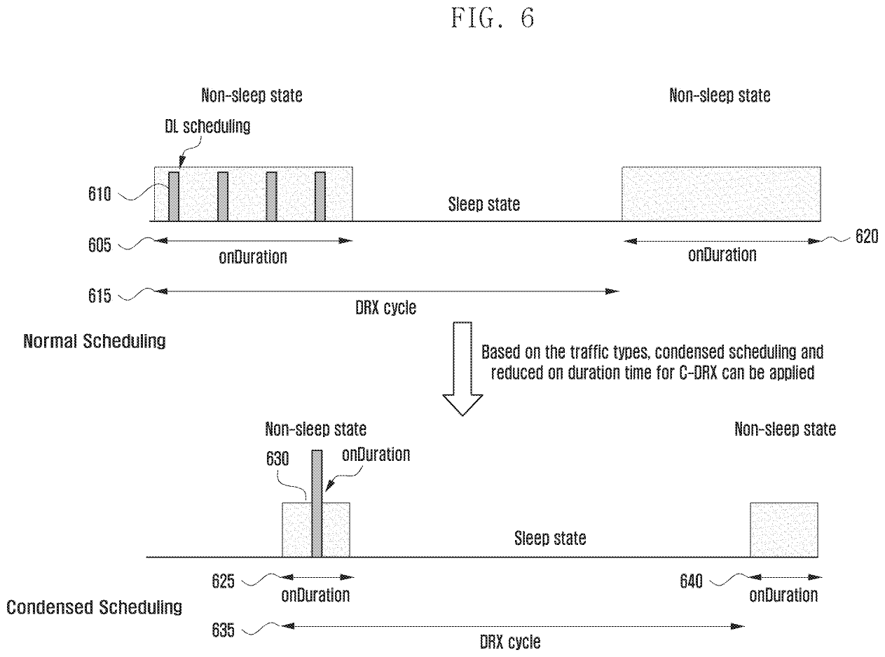

FIG. 6 is a diagram illustrating a characteristic and effect of a UE operation according to an embodiment of the disclosure.

As described with reference to FIG. 5, basically, a DRX operation in a connected state is a technology in which a UE performs monitoring only in a predetermined physical downlink control channel (PDCCH) in order to obtain scheduling information.

Referring to FIG. 6, the UE performs PDCCH monitoring during a non-sleep interval (an interval in which an on-duration timer 605 is configured). If downlink data for the UE is generated, a base station performs scheduling for packet transmission associated with corresponding traffic according to an internal operation of the base station, and transfers downlink scheduling to the UE via a PDCCH in operation 610. If the corresponding traffic is incurred again after scheduling according to the frequency of traffic and the point in time of scheduling processing/transferring, the base station may consecutively perform scheduling associated with the corresponding traffic (e.g., four consecutive times of scheduling may be performed as illustrated in FIG. 6). For reference, the base station may determine a delay time between the occurrence of the corresponding traffic and actual scheduling allocation and transmission, based on a characteristic of a predetermined traffic (e.g., QoS class indicator (QCI) or the like). Subsequently, the UE operates in a sleep mode during a DRX cycle 615, and may not perform PDCCH monitoring during the time. If the DRX cycle 615 expires, the UE performs PDCCH monitoring again during an on-duration time 620.

In terms of the UE, a processing time associated with a predetermined traffic may be different for each UE. Particularly, when the predetermined traffic is processed, a time that allows the UE to perform processing may be long even though a delay time between the occurrence of the corresponding downlink traffic and the actual reception by the UE increases. That is, a time that allows the UE to process a corresponding traffic may be different depending on traffic. In the disclosure, this is defined to be a DL tolerable delay. As an example of the DL tolerable delay, there is video streaming Generally, unlike a messenger traffic that requires an operation with a low delay time in two ways, in the case of the video streaming, a UE receives a downlink data packet with a high data rate, stores the same in a buffer, and performs video streaming in an application included in the UE. That is, in the case of a video streaming traffic, initial buffering is significantly closely related to a tolerable delay. If the UE needs to decrease power, a video streaming service may be provided without difficulty although a corresponding packet is received late by as much as a tolerable delay. For downlink reception of a predetermined traffic, the UE may reduce 625 the basically configured on-duration time of C-DRX 605 so as to reduce a time for monitoring a PDCCH. Accordingly, the power of the UE may be reduced. In terms of the base station, scheduling associated with a high data rate, which corresponds to a packet size from the point in time at which a downlink traffic (video streaming) is actually incurred to the point in time at which scheduling is transferred, may be performed in operation 630. That is, the base station may delay downlink scheduling associated with a predetermined traffic according to a DL tolerable delay which is transferred by the UE. In this instance, compared to the normal DRX operation, scheduling of the corresponding traffic may have a high data rate and may be condensed. This is defined to be condensed scheduling. Subsequently, the UE may perform communication by applying a configured DRX cycle 635 and a changed on-duration time 640.

For reference, according to a normal scheduling procedure associated with an uplink traffic, if an uplink traffic is incurred and a regular buffer status report (BSR) (R-BSR) requirement is satisfied, a UE immediately triggers an R-BSR and a scheduling request (SR) so as to request a data resource from a base station. If an uplink traffic is incurred, a PDCP module immediately reports the same to a lower layer, and may proceed with a packet transmission procedure. Conversely, a normal scheduling procedure associated with a downlink traffic, if a base station receives a downlink traffic, the base station performs scheduling a downlink packet so as to perform data transmission as fast as possible at the point in time at which the corresponding packet is transmittable.

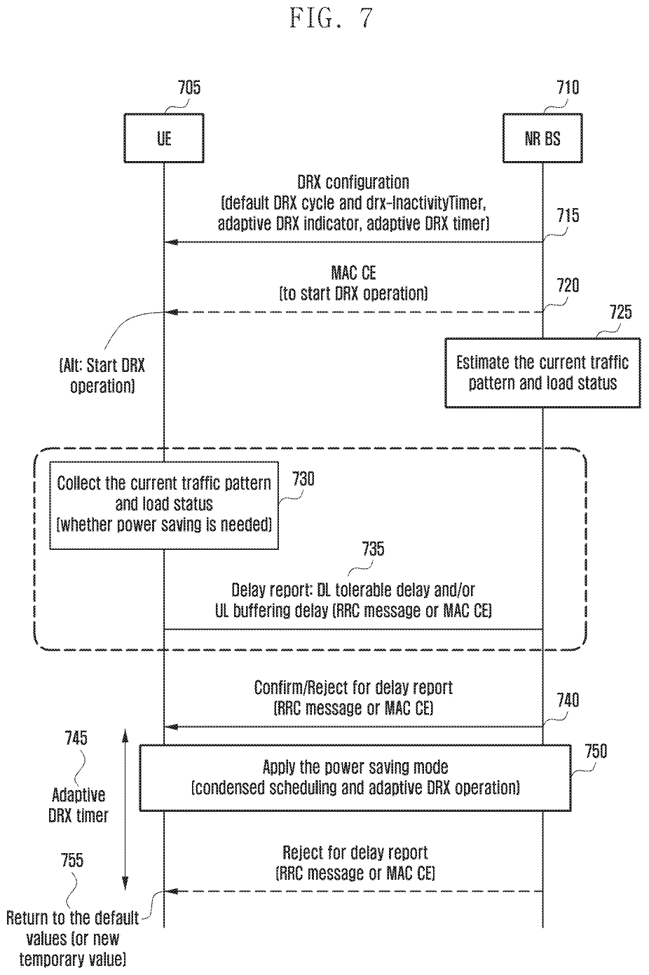

FIG. 7 is a diagram illustrating an overall operation in which an operation related to a UE request delay report and condensed scheduling are performed, when a connected mode DRX operation is performed according to an embodiment of the disclosure.

Referring to FIG. 7, a UE 705 receives DRX configuration information from a base station 710 in operation 715. The DRX configuration information may include at least one of a default DRX cycle, a default drx-InactivityTimer value, an indicator that is associated with supporting of adaptive DRX (decreasing an adaptive DRX cycle associated with a predetermined traffic and condensed scheduling) proposed in the disclosure for power saving, and a timer value (or a multiple of a default DRX instead of a timer value) that maintains a value, which is different from a default value, when the different value is applied, that is, an adaptive DRX applied timer. The UE 705 that receives the DRX configuration information may perform a DRX operation using the configuration information, immediately or from a predetermined point in time. As another example, a new MAC CE that triggers a DRX operation that complies with a DRX configuration may be defined. In this instance, the UE 705 receives a new MAC CE from the base station 710 in operation 720, and may perform a DRX operation immediately or from a predetermined point in time. The base station 710 drives an optimal DRX cycle or a drx-InactivityTimer value, based on various information such as a DRB characteristic, a traffic pattern and buffer state, a frame structure, and the like, in operation 725. For reference, according to a normal scheduling procedure associated with an uplink traffic, if an uplink traffic is incurred and a regular BSR (R-BSR) requirement is satisfied, the UE 705 immediately triggers an R-BSR and an SR so as to request a data resource from the base station 710. If the uplink traffic is incurred, a PDCP module immediately reports the same to a lower layer, and may proceed with a packet transmission procedure. Conversely, in a normal scheduling procedure associated with a downlink traffic, if the base station 710 receives a downlink traffic, the base station 710 performs scheduling a downlink packet so as to perform data transmission as fast as possible at the point in time at which the corresponding packet is transmittable.

If the base station 710 includes an indicator that is associated with supporting of adaptive DRX in the DRX configuration information and the corresponding indicator indicates that adaptive DRX is supported, and if the UE 705 needs power saving for a predetermined traffic, the UE 705 calculates tolerable delay information for the corresponding traffic (a UL buffering delay for an uplink and a DL tolerable delay for a downlink) and generates information in operation 730. One or all of the uplink delay information and the downlink delay information may be included in the delay information. In operation 735, the UE 705 may transfer, to the base station 710, a delay report message including UL/DL tolerable delay information for each DRB or each QoS flow. The message may be transferred via a new RRC message or may be transferred by being included in an existing RRC message (e.g., an UEAssistanceInformation message), or may be transferred via a new uplink MAC CE for quick transferring and identification. As described above, the content included in the message is as follows:

1. DL tolerable scheduling delay: DL tolerable delay per DRB (or per QoS flow)

a time in which a base station scheduler performs buffering before transmitting a DL traffic in order to maximize DL traffic aggregation

2. UL applied tolerable buffering delay: UL applied buffering delay per DRB (or per QoS Flow)

a waiting time until a UE triggers a scheduling request in order to maximize UL traffic aggregation

If a new MAC CE including the above information is generated, this may be configured to be a 1-bit uplink indicator+a DRB ID (or QoS flow ID)+a tolerable delay in the case of an uplink. Also, this may be configured to be a 1-bit downlink indicator+a DRB ID (or QoS flow ID)+a tolerable delay in the case of a downlink. As described above, one or all of the uplink delay information and the downlink delay information may be included in the delay information. Also, the delay information may be configured in a unit of absolute time, or may be signaled in a way that indicates the index of a candidate value.

The base station 710 that receives the delay report message may determine whether to accept a corresponding request from the UE 705. If the base station 710 accepts a power saving request (adaptive DRX and condensed scheduling) of the UE 705 in association with the corresponding traffic, the base station 710 may transfer a confirm message to the UE 705 in operation 740. If the base station 710 rejects the power saving request (adaptive DRX and condensed scheduling) of the UE 705 in association with the corresponding traffic, the base station 710 may transfer a reject message to the UE 705 in operation 740. Alternatively, if the base station 710 desires to reject the request of the UE 705, the base station 710 indicates rejection by not transmitting a reject message to the UE 705. That is, when a confirm message is not received, the UE 705 may not apply the changed configuration (request). Also, the confirm/reject message may be provided in the form of an RRC message or a downlink MAC CE. If an RRC message is used for the delay report message of the UE 705 in operation 735, an RRC message may be used for the confirm/reject message in operation 740. In the same manner, if an uplink MAC CE is used for the delay report message of the UE 705 in operation 735, a downlink MAC CE message may be used for the confirm/reject message in operation 740. The downlink confirm/reject message may simply indicate confirmation/rejection, or may indicate individual confirmation for an uplink or a downlink. The downlink confirm/reject message may specify and transfer an actually applicable uplink/downlink delay value. Through the above, a value supported therebetween may be clearly obtained via bidirectional negotiation. Regarding signaling, information similar to the content of the above-mentioned delay report message may be transferred in the form of a similar signaling. That is, if a new MAC CE including the above content is generated, signaling associated with an uplink may be configured to be a 1-bit uplink indicator+a DRB ID (or QoS flow ID)+a tolerable delay. Also, signaling associated with a downlink may be configured to be a 1-bit downlink indicator+a DRB ID (or QoS flow ID)+a tolerable delay, in the case of a downlink.

If the UE 705 receives a confirm message from the base station 710, the UE 705 may start a previously configured adaptive DRX timer in operation 745, and at the same time, the UE 705 and the base station 710 may apply a power saving operation in operation 750. The power saving operation may include an operation of reducing an on-duration timer value of C-DRX according to a downlink tolerable delay transferred from the UE 705, and increasing an actual DRX operation time by as much as the decreased time. Also, from the perspective of the base station 710, the base station 710 delays a time for scheduling a downlink data packet associated with a corresponding traffic, whereby condensed scheduling may be enabled. From the perspective of the UE 705, although an uplink data packet associated with the corresponding traffic is incurred, the UE 705 stores the same in a buffer, delays transmission, and transmits the same to the base station 710. That is, although the corresponding traffic is incurred, the UE 705 does not immediately generate a buffer status report (BSR) and transmit a scheduling request (SR) to the base station 710, but rather the UE 705 waits as long as a configured uplink tolerable delay, generates a BSR for a data packet at that point in time (i.e., a data packet accumulated during a tolerable delay after the traffic is incurred), triggers an SR, transfers the BSR, and performs data transmission. This is also considered as an uplink version of a downlink condensed scheduling. However, the point in time at which the UE 705 generates and transfers a BSR and an SR, and the content that the UE 705 actually reports may be different.

When configuring DRX in operation 715, if an indicator that is associated with supporting of adaptive DRX (decreasing an adaptive DRX cycle associated with a predetermined traffic and condensed scheduling) and a timer value (a multiple of default DRX instead of a timer value) that maintains a value different from a default value when the different value is applied, that is, an adaptive DRX applied timer, are provided, an adaptive DRX applied timer that started in operation 745 operates until the time reaches a previously provided expiration value of the adaptive DRX applied timer, and an applied power saving operation may be stopped when the corresponding timer expires. Alternatively, if the corresponding timer is not configured, or if the base station 710 desires to stop the power saving operation even though the timer is configured, the base station 710 indicates stopping the corresponding operation to the UE 705 via a reject message (RRC message or downlink MAC CE), which has been described in operation 740, in operation 755. The UE 705 may immediately stop the power saving operation upon receiving the message. If the UE 705 desires to change or stop a configuration associated with the predetermined traffic before operation 755, the UE 705 may perform operation 735 again to request changing and stopping the configuration. When requesting stopping, the UE 705 may request the base station 710 to change an uplink/downlink delay report value associated with an operating traffic to a default value.

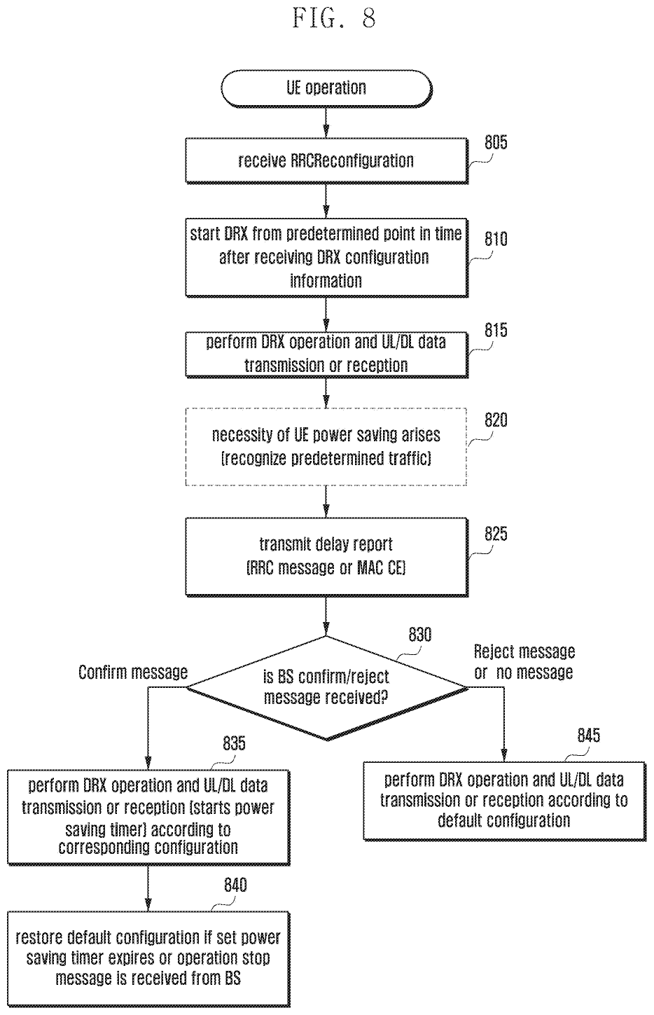

FIG. 8 is a diagram illustrating an overall UE operation in which an operation related to a UE request delay report and condensed scheduling are performed according to an embodiment of the disclosure.

Referring to FIG. 8, in operation 805, a UE may receive an RRCReconfiguration message. The RRCReconfiguration message may include a DRB configuration (DRBAddToMod), PDCP discard timer information (a timer indicating discard when a packet is not received during a predetermined period of time), a DRX configuration, a scheduling request configuration, and the like. Also, the DRX configuration information may include at least one of a default DRX cycle, a default drx-InactivityTimer value, an indicator that is associated with supporting of adaptive DRX (decreasing an adaptive DRX cycle associated with a predetermined traffic and condensed scheduling) proposed in the disclosure for power saving, and a timer value (or a multiple of a default DRX instead of a timer value) that maintains a value, which is different from a default value, when the different value is applied, that is, an adaptive DRX applied timer. The UE that receives the DRX configuration information in operations 810 to 815, may perform a DRX operation using the configuration information immediately or from a predetermined point in time. If a base station signals that an indicator that is associated with supporting adaptive DRX is supported when providing the DRX configuration, the UE may recognize a traffic (for each DRB or QoS flow) that needs power saving, and may determine to request power saving for the corresponding traffic in operation 820. If the base station 710 includes an indicator that is associated with supporting of adaptive DRX in the DRX configuration information of the RRCReconfiguration message transferred by the base station, and the corresponding indicator indicates that adaptive DRX is supported, and if the UE needs power saving for the predetermined traffic, the UE calculates tolerable delay information for the corresponding traffic (a UL buffering delay for an uplink and a DL tolerable delay for a downlink) and generates information in operation 825. One or all of the uplink delay information and the downlink delay information may be included in the delay information. The UE may transfer, to the base station, a delay report message including UL/DL tolerable delay information for each DRB or QoS flow. The message may be transferred via a new RRC message or may be transferred via an existing RRC message (e.g., an UEAssistanceInformation message), or may be transferred via a new uplink MAC CE for quick transferring and identification. A detailed description of the delay report has been described with reference to FIG. 7.

If the UE requests adaptive DRX and condensed scheduling for power saving in operation 825, the UE performs a different operation depending on a message received from the base station in operation 830. If the UE receives a confirm message in operation 830, the UE starts a previously configured adaptive DRX timer, and at the same time, the UE and the base station applies a power saving operation in operation 835. The power saving operation may include an operation of reducing an on-duration timer value of C-DRX according to a downlink tolerable delay transferred from the UE, and increasing an actual DRX operation time by as much as the decreased time. Also, the condensed scheduling operation in an uplink/downlink may be summarized as follows:

### 1. Delayed Scheduling for Uplink Traffic

trigger an R-BSR and an SR after a UL applied buffering delay elapses even though an uplink traffic is incurred and a regular BSR requirement is satisfied
a PDCP module drives a UL applied buffering delay timer when a UL traffic is incurred. If a timer expires, the occurrence of data is reported to a lower layer.

### 2. Delayed Scheduling for Downlink Traffic

if a base station receives a DL packet, the base station transmits data at the point in time which is the closest to a DL tolerable delay, or collects packets generated during the DL tolerable delay and transmits a data packet at the point in time that is closest to the DL tolerable delay
operates a timer (a value less than a DL tolerable delay) when a DL packet is received. If a timer expires, scheduling associated with a corresponding QoS flow (or DRB) starts

Subsequently, if a configured power saving timer (adaptive DRX timer) expires or a stop message is received from the base station, the UE may restore a default configuration and performs data transmission or reception and a C-DRX operation in operation 840.

If the UE receives a reject message from the base station (or does not receive any message from the base station) in operation 830, the UE restores a default configuration and performs data transmission or reception and a C-DRX operation in operation 845. For reference, the delay report message and the delay report confirm/reject message may be transferred using an RRC message or a MAC CE, and the detailed description thereof is included in the description of FIG. 7.

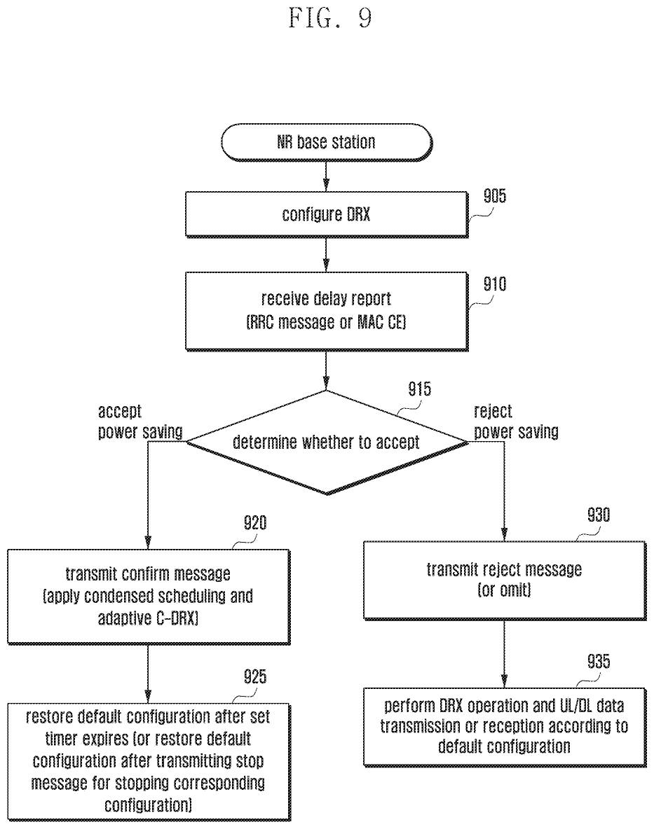

FIG. 9 is a diagram illustrating an overall base station operation in which an operation related to a UE request delay report and condensed scheduling are performed according to an embodiment of the disclosure.

Referring to FIG. 9, a base station provides a DRX configuration to a UE in a connected state, via an RRCReconfiguration message in operation 905. The DRX configuration information may include at least one of a default DRX cycle, a default drx-InactivityTimer value, an indicator that is associated with supporting of adaptive DRX (decreasing an adaptive DRX cycle associated with a predetermined traffic and condensed scheduling) proposed in the disclosure for power saving, and a timer value (or a multiple of a default DRX instead of a timer value) that maintains a value, which is different from a default value, when the different value is applied, that is, an adaptive DRX applied timer. The UE that receives the DRX configuration information may perform a DRX operation using the configuration information, immediately or from a predetermined point in time. If the base station signals that an indicator that is associated with supporting of adaptive DRX is supported when providing the DRX configuration, the base station may receive a delay report transferred from the UE in operation 910. The delay report may be provided in the form of an RRC message or a MAC CE, and the detailed description thereof has been provided with reference to FIG. 7.

In operation 915, the base station may determine whether to accept or reject a request from the UE. If the base station determines to accept a power saving operation associated with the delay report from the UE, the base station may generate a confirm message associated with the delay report and may transfer the same to the UE in operation 920. The downlink confirm message may simply indicate confirmation, or may indicate individual confirmation for an uplink or a downlink. The downlink confirm message may specify and transfer an actually applicable uplink/downlink delay value. Through the above, a value supported therebetween may be clearly obtained via bidirectional negotiation. If a new MAC CE including the above-described content is generated, signaling associated with an uplink may be configured to be a 1-bit uplink indicator+a DRB ID (or QoS flow ID)+a tolerable delay. Also, signaling associated with a downlink may be configured to be a 1-bit downlink indicator+a DRB ID (or QoS flow ID)+a tolerable delay. In the same manner, the base station transfers the message to the UE, and simultaneously, applies condensed scheduling and adaptive C-DRX. If the adaptive DRX applied timer configured in operation 905 is provided, the base station performs the power saving operation until the corresponding timer expires, and if the corresponding timer expires, the base station restores a default configuration in operation 925. If the corresponding timer is not configured, or the base station desires to stop the power saving operation even though the timer is configured, the base station indicates stopping the corresponding operation via a reject message (an RRC message or a downlink MAC CE) for the corresponding configuration.

In operation 915, the base station may determine whether to accept or reject a request from the UE. If the base station determines not to accept a power saving operation associated with the delay report of the UE, the base station may generate a reject message associated with the corresponding report message and may transfer the same to the UE in operation 930. The base station performs data transmission or reception and a C-DRX operation according to the default configuration in operation 935.

Also, the confirm/reject message may be provided in the form of an RRC message or a downlink MAC CE. If an RRC message is used for the delay report message of the UE in operation 910, an RRC message may be used for the confirm/reject message in a subsequent operation. In the same manner, if an uplink MAC CE is used for the delay report message of the UE in operation 910, a downlink MAC CE message may be used for the confirm/reject message in a subsequent operation.

Embodiment 2 considers a method of performing transition of a connected state to an inactive state (INACTIVE) depending on the type of traffic of a UE, compared to an existing operation in which a UE performs transition of a connected state to an idle state (IDLE) in the NR system when a data inactivity timer (dataInactivityTimer) expires. Basically, the UE may best recognize the traffic type of traffic incurred by the UE, and the period and frequency of generation of traffic may be different for each communication service. For example, in the case of a messenger service, it may be expected that data is frequently generated and subsequent data is incurred. However, in the case of a predetermined session service, it may be recognized that subsequent data is generated a long time after data transmission or reception is performed. Therefore, the disclosure proposes a procedure in which a UE requests a UE state, so that a UE state to which the UE is to perform transition after data inactivity timer (dataInactivityTimer) expires may be different depending on the type of traffic.

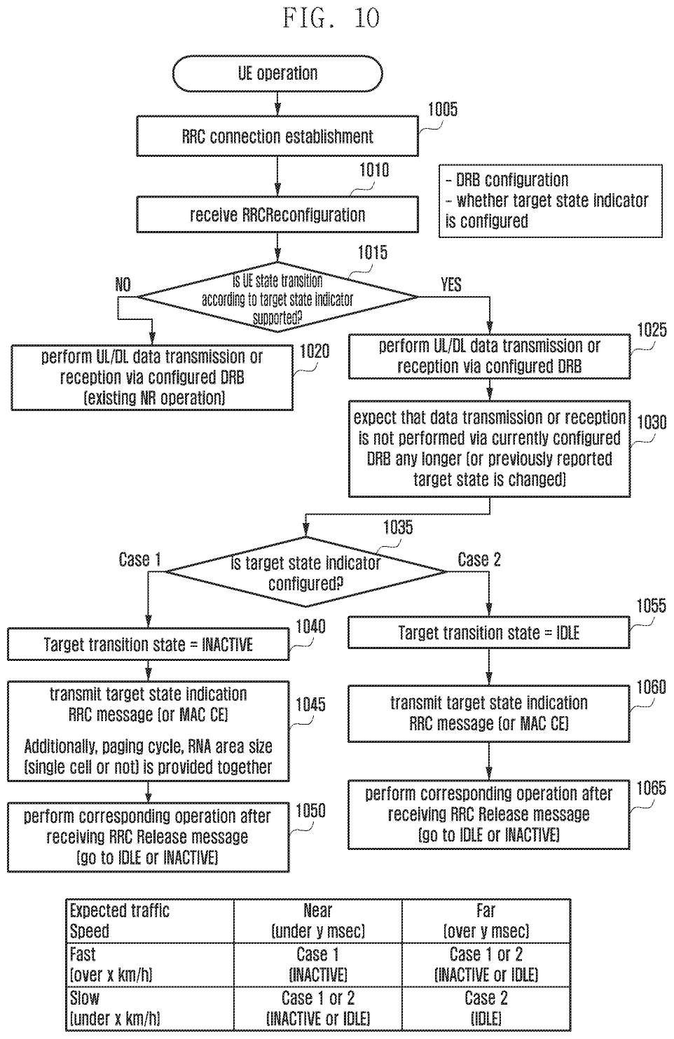

FIG. 10 is a diagram illustrating an overall UE operation that requests a state to which a UE is to perform transition when a data inactivity timer expires according to an embodiment of the disclosure.

Referring to FIG. 10, a UE performs an RRC connection procedure by reason of data transmission or reception with a predetermined cell of a base station which the UE camps on, and establishes an RRC connection in operation 1005. In operation 1010, the UE may receive an RRC reconfiguration configuration from the corresponding serving cell. The corresponding configuration may include a DRB configuration, a cell group configuration, a MAC configuration, and the like. Also, the configuration included in the RRC reconfiguration message may include an indicator (information) indicating whether the corresponding base station (serving cell) supports transition of a UE state according to a target state indication (target state indicator) requested by the UE.

In operation 1015, the UE determines whether the indicator, indicating whether the base station supports transition of a UE state according to a target state indication requested by the UE, is included in the RRC reconfiguration message, and may perform an operation differently depending on the result. If the indicator is not included in the RRC reconfiguration message, or it is indicated that the indicator is not supported, the UE performs UL/DL data transmission or reception via a configured DRB in operation 1020. That is, an existing data transmission or reception operation in the NR system may be performed.

If the indicator, indicating whether the base station supports transition of a UE state according to a target state indication requested by the UE, is included in the RRC reconfiguration message, and it is indicated that the corresponding operation is supported in operation 1015, the UE proceeds with UL/DL data transmission or reception via a configured DRB in operation 1025, and if it is expected that no more data transmission or reception is performed via the currently configured DRB (or if a previously reported target state is changed) in operation 1030, the UE may configure a target state indicator in operation 1035. The method of configuring a target state may be performed according to Table 1 below.

TABLE 1

| Expected traffic | Near | Far |
|---|---|---|
| Speed | (under y msec) | (over y msec) |
| Fast | Case 1 | Case 1 or 2 |
| (over x km/h) | (INACTIVE) | (INACTIVE or IDLE) |
| Slow | Case 1 or 2 | Case 2 |
| (under x km/h) | (INACTIVE or IDLE) | (IDLE) |

For example, in case 1, target state=INACTIVE, that is,
the point in time at which a subsequent traffic is expected to be incurred is less than or equal to y msec, or
if the current movement speed of a UE is greater than or equal to x km/h

In case 2, target state=IDLE, that is,
the point in time at which a subsequent traffic is expected to be incurred is greater than or equal to y msec, and
the current movement speed of a UE is less than or equal to x km/h

If the speed of the UE is fast, or the point in time at which traffic is expected to be incurred is short, the probability that data will be triggered again within a short time is high. However, determining IDLE or INACTIVE according to the conditions may comply with a UE's internal operation, as described in the table.

That is, if the UE determines that it is case 1 in operation 1035, the UE sets the target state indicator to INACTIVE in operation 1040, and transmits a Target State Indication RRC message to the base station in operation 1045. In the operation, since the state transition is a function which the RRC layer is in charge of, the target state indicator may be transferred via an RRC message in consideration of CU-DU split. In this instance, an existing UEAssistanceInformation message may be reused, or a new dedicated-RRC message may be introduced. However, if CU-DU is not taken into consideration, a target state indicator may be indicted via a MAC CE for fast transferring and reduction of a delay. In operation 1045, the UE may additionally provide a desired paging cycle, a RAN notification area size (single cell or not). In operation 1050, the UE may receive an RRCRelease message from the base station, and may perform transition to a state indicated by the base station. The target state indicator transferred by the UE is merely a request from the UE. The base station may accept the request from the UE or the base station may indicate transition to a different state based on a decision made by the base station.

If the UE determines that it is case 2 in operation 1035, the UE sets the target state indicator to IDLE in operation 1055, and transmits a Target State Indication RRC message to the base station in operation 1060. In operation 1065, the UE may receive an RRCRelease message from the base station, and may perform transition to a state indicated by the base station. The target state indicator transferred by the UE is merely a request from the UE. The base station may accept the request from the UE or the base station may indicate transition to a different state based on a decision made by the base station.

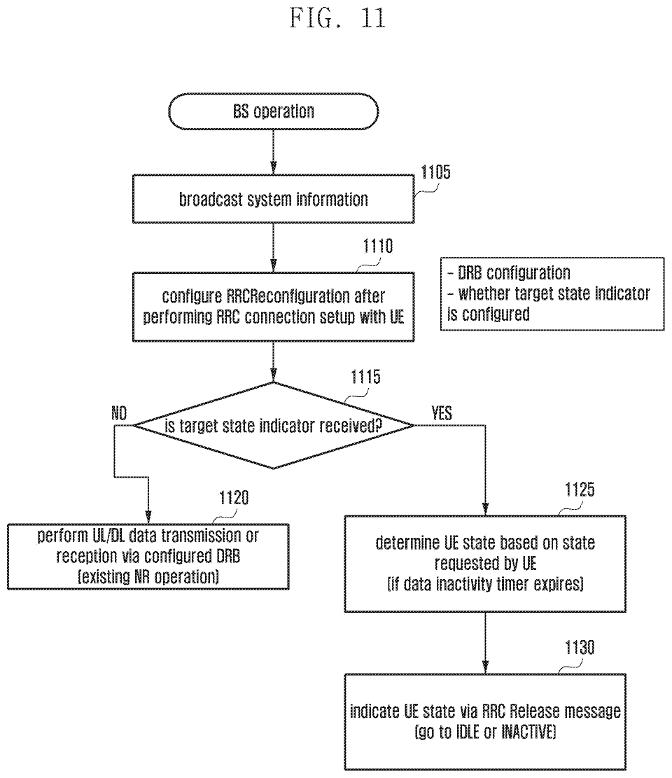

FIG. 11 is a diagram illustrating an overall base station operation that requests a state to which a UE is to perform transition when a data inactivity timer expires according to an embodiment of the disclosure.

Referring to FIG. 11, a base station may broadcast system information in operation 1105. In operation 1110, the base station performs an RRC connection procedure with a predetermined UE, sets various configuration information after establishing an RRC connection with the corresponding UE, and transfers an RRCReconfiguration message including the corresponding information to the UE. The configuration may include a DRB configuration, a cell group configuration, a MAC configuration, and the like. Also, the configuration included in the RRC reconfiguration message may include an indicator (information) indicating whether the base station (serving cell) supports transition of a UE state according to a target state indication requested by the UE.

In operation 1115, the base station may receive a target state indication (target state indicator) via an RRC message from the UE, may determine which state is indicated by the corresponding target state indication, and may perform an operation differently depending on the result. As described above, an MAC CE may be used, instead of an RRC message. If the base station does not receive an RRC message (or MAC CE) including a target state indication from the UE, or a target state indication is not included in the corresponding message in operation 1115, the base station proceeds with UL/DL data transmission or reception via a configured DRB in operation 1120. That is, an existing data transmission or reception operation in the NR system may be performed.

If the base station receives an RRC message (or MAC CE) including a target state indication from the UE, and the target state indication is indicated in the corresponding message in operation 1115, the base station may determine a UE state based on a state requested by the UE in operation 1125. The corresponding operation corresponds to the case in which a previously configured data inactivity timer expires or the base station desires to change a UE to another state. That is, if a situation corresponds to one of the two conditions and the base station determines a UE state, the base station indicates the UE state via an RRC Release message so as to command transition to an IDLE state or an INACTIVE state in operation 1130. The target state indicator transferred by the UE is merely a request from the UE. The base station may accept the request from the UE or the base station may indicate transition to a different state based on a decision made by the base station.

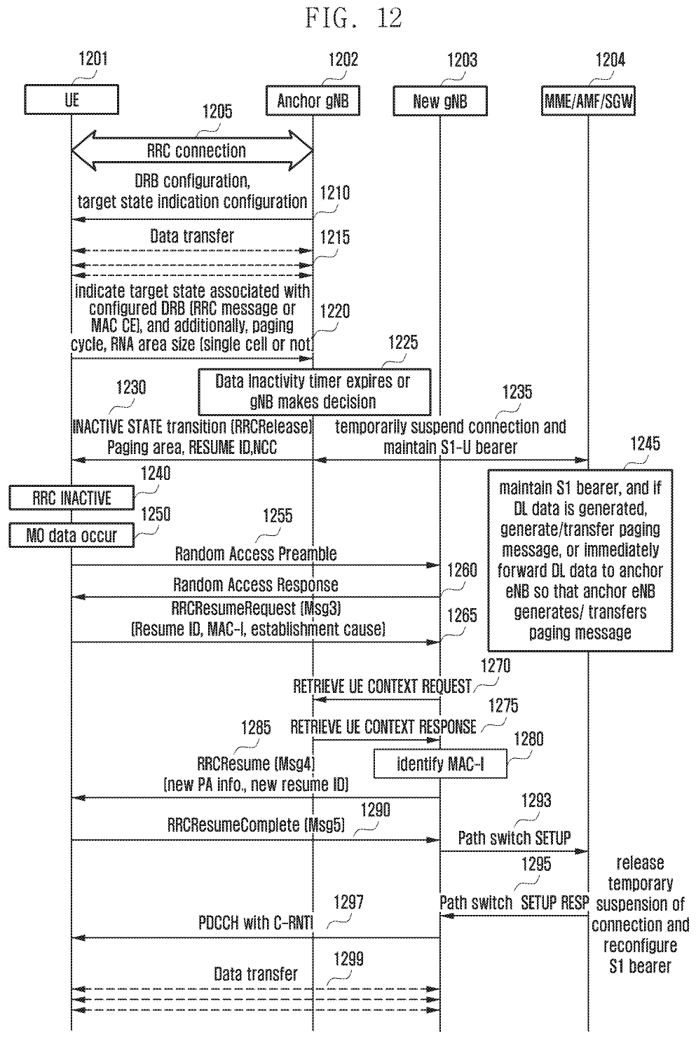

FIG. 12 is a diagram illustrating an overall procedure in which a UE in a connected state performs transition to an RRC inactive mode according to a request of the UE if a data inactivity timer expires according to an embodiment of the disclosure.

Referring to FIG. 12, the overall flow among a UE 1201, an anchor gNB 1202, a new gNB 1203, and an mobility management function (AMF) 1204, in order to perform a procedure of reusing a UE context and an S1 bearer between the UE 1201 and the anchor gNB 1202 and the new gNB 1203 is illustrated.

The UE 1201 in an RRC connected state 1205 receives an RRC reconfiguration message from the anchor gNB 1202, and identifies a DRB configuration, whether the gNB supports a target state requested by the UE, and the like, included in the corresponding configuration, in operation 1210. Subsequently, the UE 1201 performs data transmission or reception with the anchor gNB 1202 in operation 1215.

While the UE 1201 performs UL/DL data transmission or reception via a configured DRB, if it is expected that data transmission or reception via the currently configured DRBs is not performed any longer (or a previously reported target state is changed), the UE 1201 configures a target state indicator and transfers a corresponding request message to the anchor gNB 1202 in operation 1220. The method of configuring the target state indicator has been described in detail with reference to FIG. 10. In operation 1220, the UE 1201 may provide, to the anchor gNB 1202, a desired paging cycle, a RAN notification area size (single cell or not), in addition to the target state indicator.

If the data transmission or reception is suspended, the anchor gNB 1202 operates a predetermined timer (data inactivity timer), and if data transmission or reception is not resumed until the timer expires in operation 1225, the anchor gNB 1202 may consider releasing the RRC connection with the UE 1201. The anchor gNB 1202 may determine whether the UE 1201 is to be changed to an RRC idle mode or an RRC inactive mode, according to a predetermined condition. As the predetermined condition, the degree of network traffic, the amount of UE context that a network can hold, the number of UEs to which a network is capable of supporting a service, and the like may be considered. However, in the embodiment, the anchor gNB 1202 may make a decision based on the desired state requested by the UE 1201 in operation 1220. In the embodiment, the case in which the anchor gNB 1202 performs transition of the UE 1201 to an INACTIVE state in operation 1225 will be considered.

In operation 1230, the anchor gNB 1202 indicates transition of the UE 1201 to the INACTIVE state, via an RRCRelease message. The anchor gNB 1202 releases the RRC connection of the UE 1201 according to a predetermined rule, stores a UE context, transmits a control message indicating release of the RRC connection to the UE 1201, assigns a Resume ID, and configures a paging area (PA) in association with reporting mobility while the UE 1201 is in an inactive state. Based on the allocation of the Resume ID, the UE 1201 may identify that the UE 1201 needs to store the UE context. Alternatively, the anchor gNB 1202 may separately include a context maintain indication in the message, and may transmit the same to the UE 1201, in order to direct the UE 1201 to operate in an RRC inactive mode and to store the UE context. The message may include security information for updating a security configuration needed when the UE 1201 performs an RRC connection resume procedure later on. For example, the UE 1201 may receive NextHopChainingCount (NCC) in advance, and may calculate and configure a new security key (KeNB* or KgNB*) using the same. Also, the control message may include a period during which the anchor gNB 1202 maintains the context, or a list of cells to which a procedures of using the stored context may be applied when the UE 1201 desires to reestablish an RRC connection within a valid period.

The anchor gNB 1202 may release the RRC connection of the UE 1201, and maintain the UE context and an S1 bearer of the UE 1201 as they are in operation 1235. The S1 bearer refers to an S1-control bearer, which is used for transmitting or receiving a control message between the anchor gNB 1202 and the AMF 1204, and an S1-user plane bearer, which is used for transmitting or receiving user data between the anchor gNB 1202 and a user plane function (UPF) (not illustrated). Since the S1 bearer is maintained, a procedure of configuring an S1 bearer may be omitted when the UE 1201 attempts to establish an RRC connection in the same cell or the same anchor gNB 1202. If the validity period expires, the anchor gNB 1202 may delete the UE context and release the S1 bearer. The UE 1201 that receives an inactive mode transition RRC message in operation 1230 may change to an RRC inactive mode. The S1 bearer may be called by another name in the NR system.

In the above-description, the anchor gNB 1202 is a gNB that maintains and manages a UE context (resume ID) of the RRC inactive mode UE, and manages an RAN paging area (or RAN notification area) for managing the mobility of the RRC inactive mode UE. The access and mobility management function (AMF) 1204 may perform the above-described role of the anchor gNB 1202, instead of the anchor gNB 1202.

The anchor gNB 1202 transmits, to the AMF 1204, a control message for requesting temporarily suspending of connection and maintaining of an S1-U bearer in operation 1235. The AMF 1204 that receives the control message may enable a UPF to immediately transmit downlink data to the anchor gNB 1202 when downlink data to the UE 1201 is incurred, so that the anchor gNB 1202 generates and transfers a paging message to a neighboring gNB in operation 1245. That is, the anchor gNB 1202 that receives the downlink data stores the data in a buffer, and proceeds with a paging procedure.

The UE 1201 that receives the inactive mode transition RRC message including the information indicating maintaining of context and Resume ID in operation 1230 may release the RRC connection. However, the UE 1201 may operate a timer corresponding to a valid period, and record a valid cell list in a memory, may not delete the current UE context but maintain the same in the memory, and may change to an inactive mode in operation 1240. The UE context refers to various information associated with an RRC configuration of the UE 1201, and may include SRB configuration information, DRB configuration information, security key information, and the like.

Subsequently, a need to establish an RRC connection according to data traffic (mobile oriented (MO)) incurred from the UE 1201 may arise, in operation 1250. A UE that does not receive a Resume ID in the previous inactive transition process or that does not receive an indication associated with maintaining of context may initiate a normal RRC connection setup process. However, the RRC inactive mode UE 1201 that receives a Resume ID in the previous RRC connection release process may attempt an RRC connection resume process using the stored UE context. That is, if the UE 1201 does not support the RRC inactive mode, a normal RRC connection setup process is performed. If the RRC inactive mode is supported, an RRC connection resume procedure may be performed as follows. The RRC inactive mode may be always supported in a network (therefore, there is no need to report whether the RRC inactive mode is supported, via system information).

First, the UE 1201 may transmit a preamble to the anchor gNB 1202 and the new gNB 1203 via message 1 in order to perform a random access procedure in operation 1255. If resource allocation is possible according to the preamble obtained via message 1, the anchor gNB 1202 and the new gNB 1203 may allocate an uplink resource corresponding thereto to the UE 1201 via message 2 in operation 1260. The UE 1201 includes the Resume ID received in operation 1230 in a Resume request message, and transmits the same to the anchor gNB 1202 and the new gNB 1203 based on the received uplink resource information in operation 1265. According to embodiments, if the UE 1201, which released connection with the anchor gNB 1202 and has been in the RRC inactive mode, moves and camps on the cell of the new gNB 1203, the new gNB 1203 receives and identifies the Resume ID of the UE and recognizes a gNB (the anchor gNB 1202) from which the corresponding UE 1201 received a service previously. If the new gNB 1203 successfully receives and identifies the Resume ID, the new gNB 1203 proceeds with a procedure of retrieving the UE context from the previous anchor gNB 1202 (a context retrieve procedure, operations 1270 and 1275). If the new gNB 1203 fails to retrieve the UE context in operations 1270 and 1275, for example, if the new gNB 1203 fails by reason that the new gNB 1203 does not find the anchor/source gNB 1202, the context of the UE 1201 does not exists, or the like, the new gNB 1203 may transmit an RRCSetup message, as opposed to an RRCResume message, to the UE 1201. The new gNB 1203 may fall back a subsequent bearer configuration procedure/security configuration procedure as the RRC connection setup procedure, and may complete the security configuration and send the UE 1201 to the RRC connection mode, or may return the UE 1201 to the RRC inactive mode again by transmitting an RRCReject message together with a new UE identifier (Resume ID) and an RAN paging area. The new gNB 1203 may retrieve the UE context from the previous anchor gNB 1202 via an S1 or X2 interface. (If the new gNB 1203 does not successfully identify the UE 1201 due to a predetermined reason although the new gNB 1203 receives the Resume ID, the new gNB 1203 may transmit an RRCSetup message to the UE 1201 so that the UE 1201 returns to a normal RRC connection setup procedure. That is, if the new gNB 1203 transmits the RRCSetup message to the UE 1201, and the UE 1201 receives the message, the UE 1201 sends an RRCSetupComplete message to the new gNB 1203 so as to set up a connection. Alternatively, if the new gNB 1203 does not successfully identify the UE 1201 although the new gNB 1203 receives the Resume ID (for example, if the new gNB 1203 fails to retrieve the UE context from the previous anchor gNB 1202), the new gNB 1203 transmits an RRCRelease message or an RRCReject message to the UE 1201, and rejects connection of the UE 1201 so that the UE 1201 attempts a normal RRC connection setup procedure again from the beginning)

The new gNB 1203 identifies MAC-I based on the retrieved UE context in operation 1280. The MAC-I is a message authentication code that the UE 1201 calculates, in association with the control message, by applying security information of the restored UE context, that is, a security key and a security counter. The new gNB 1203 may identify the integrity of the message using the MAC-I of the message, the security key and security counter, and the like stored in the context of the UE 1201, and the like.

The anchor gNB 1202 or the new gNB 1203 may determine a configuration to be applied to the RRC connection of the UE 1201, and may transmit an RRC connection resume message (RRCResume) including the configuration information to the UE 1201 in operation 1285. The new gNB 1203 identifies the UE identifier (Resume ID) of the UE 1201, encrypts the RRC connection resume message using a new security key (KeNB* or KgNB*), and transmits the same. The UE 1201 may decrypt the RRC connection resume message using a new security key KeNB* or KgNB*) calculated using an NCC allocated in advance in operation 1230, and may normally receive the RRC connection resume message. After the procedure of transmitting the RRC connection resume message, RRC messages and data may be encrypted with the new security key and may be transmitted or received between the UE 1201 and the new gNB 1203. The RRC connection resume message may be a control message including information (REUSE INDICATOR) indicating “reuse of RRC context” in a normal RRC connection request message. The RRC connection resume message may include various information related to RRC connection setup of the UE 1201, such as an RRC connection setup message. If the UE 1201 receives a normal RRC connection setup message (RRCSetup), the UE 1201 sets up an RRC connection based on configuration information indicated by the RRC connection setup message. However, if the UE 1201 receives an RRC connection resume message, the UE 1201 may set up an RRC connection (delta configuration) by taking into consideration stored configuration information and configuration information indicated by the control message. The UE 1201 determines configuration information to be applied by determining the indicated configuration information as delta information associated with the stored configuration information, and may update configuration information or UE context. For example, if SRB configuration information is included in the RRC connection resume message, the UE 1201 may configure an SRB by applying the SRB configuration information which is indicated. If the SRB configuration information is not included in the RRC connection resume message, the UE 1201 may configure an SRB by applying SRB configuration information stored in the UE context.

The UE 1201 may configure an RRC connection by applying the updated UE context and configuration information, and may transmit an RRC connection resume complete message (RRCResumeComplete) to the new gNB 1203 in operation 1290. The new gNB 1203 may transmit, to the AMF 1204, a control message for requesting releasing of temporary suspension of connection, and requests reconfiguring an S1 bearer with respect to the new gNB 1203 in operation 1293 and 1205. If the AMF 1204 receives the message, the AMF 1204 directs the UPF to reconfigure the S1 bearer with respect to the new gNB 1203, and to normally process data for the UE 1201. If the above-mentioned process is completed, the new gNB 1203 may transfer a resource associated with the MO data of the UE 1201 via a PDCCH in operation 1297, and the UE 1201 may resume data transmission or reception in the cell in operation 1299.

In the procedure, if the UE 1201, which released the connection with the anchor gNB 1202 and has been in the RRC inactive mode, does not move far and camps on the anchor gNB 1202 of the previous anchor gNB again, the anchor gNB 1202 may not proceed with a procedure of operations 1270 and 1275, may perform releasing temporary suspension of connection of an S1 bearer instead of operation 1293 and 1295, may search for the UE context of the UE 1201 based on an Resume ID indicated by message 3, and, based on the same, may reconfigure the connection according to a similar method as the above-described procedures.

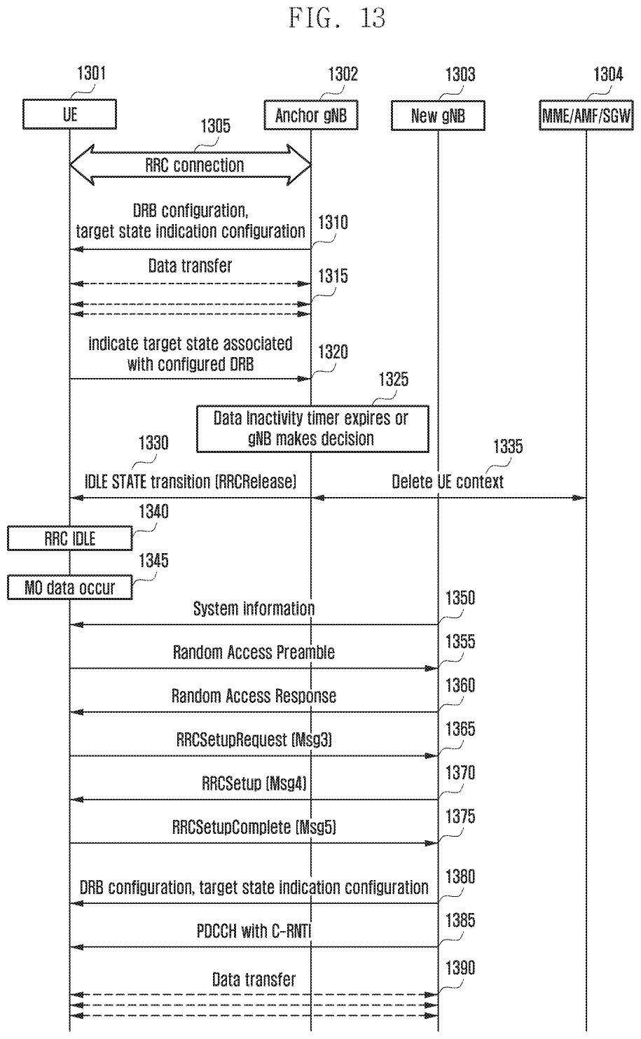

FIG. 13 is a diagram illustrating an overall procedure in which a UE in a connected state performs transition to an RRC idle mode according to a request of the UE if a data inactivity timer expires, according to an embodiment of the disclosure.

Referring to FIG. 13, a UE 1301 in an RRC connected state 1305 receives an RRC reconfiguration message from an anchor gNB 1302, and identifies a DRB configuration, whether the gNB supports a target state requested by the UE, and the like included in the corresponding configuration, in operation 1310. Subsequently, the UE 1301 performs data transmission or reception with the anchor gNB 1302 in operation 1315.

While the UE 1301 performs UL/DL data transmission or reception via a configured DRB, if it is expected that data transmission or reception via the currently configured DRBs is not performed any longer (or a previously reported target state is changed), the UE 1301 configures a target state indicator and transfers a corresponding request message to the anchor gNB 1302 in operation 1320. The method of configuring the target state indicator has been described in detail with reference to FIG. 10.

If the data transmission or reception is suspended, the anchor gNB 1302 operates a predetermined timer (data inactivity timer), and if data transmission or reception is not resumed until the timer expires in operation 1325, the anchor gNB 1302 may consider releasing the RRC connection with the UE 1301. The anchor gNB 1302 may determine whether the UE 1301 is to be changed to an RRC idle mode or an RRC inactivated mode, according to a predetermined condition. As the predetermined condition, the degree of network traffic, the amount of UE context that a network can hold, the number of UEs to which a network is capable of supporting a service, and the like may be considered. However, in the embodiment, the anchor gNB 1302 may make a decision based on the desired state requested by the UE 1301 in operation 1320. In the embodiment, the case in which the anchor gNB 1302 performs transition of the UE 1301 to an IDLE state in operation 1325 will be considered.

In operation 1330, the anchor gNB 1302 indicates transition of the UE 1301 to the IDLE state, via an RRCRelease message. In operation 1335, the anchor gNB 1302 may delete UE context to AMF 1304 in operation 1335 according to a predetermined rule, and may release the RRC connection of the UE 1301 in operation 1340.

Subsequently, a need to setup an RRC connection according to data traffic (mobile oriented (MO)) incurred from the UE 1301 may arise, in operation 1345. That is, the UE 1301 receives system information associated with the cell that the UE 1301 camps on and reselects in operation 1350, and proceeds with an RRC connection procedure. First, the UE 1301 may transmit a preamble to a new gNB 1303 via message 1 in order to perform a random access procedure in operation 1355. If resource allocation is possible according to the preamble received via message 1, the new gNB 1303 may allocate an uplink resource corresponding thereto to the UE 1301 via message 2 in operation 1360. The UE 1301 transmits an RRC connection request message received in operation 1330 to the new gNB 1303 based on the received uplink resource information in operation 1365. The new gNB 1303 transmits an RRCSetup message and proceeds with a bearer configuration procedure as an RRC connection setup procedure, that is, the new gNB 1303 transmits the RRCsetup message to the UE 1301 in operation 1370. If the UE 1301 receives the RRCSetup message, the UE 1301 may send an RRCSetupComplete message to the new gNB 1303 so as to setup a connection in operation 1375. In operation 1380, the UE 1301 receives a new RRC reconfiguration message from the new gNB 1303, and complies with the configuration.

If the above-mentioned process is completed, the new gNB 1303 may transfer a resource associated with the MO data of the UE 1301 via a PDCCH in operation 1385, and the UE 1301 may resume data transmission or reception in the new gNB 1303 in operation 1390. Although it is illustrated that the UE 1301 connects to the new gNB 1303 in FIG. 13, if the UE 1301, which has been in the RRC idle state, does not move far, and camps on the anchor gNB 1302 of the previous anchor gNB again, the UE 1301 may set up an RRC connection to the previous anchor gNB 1302.

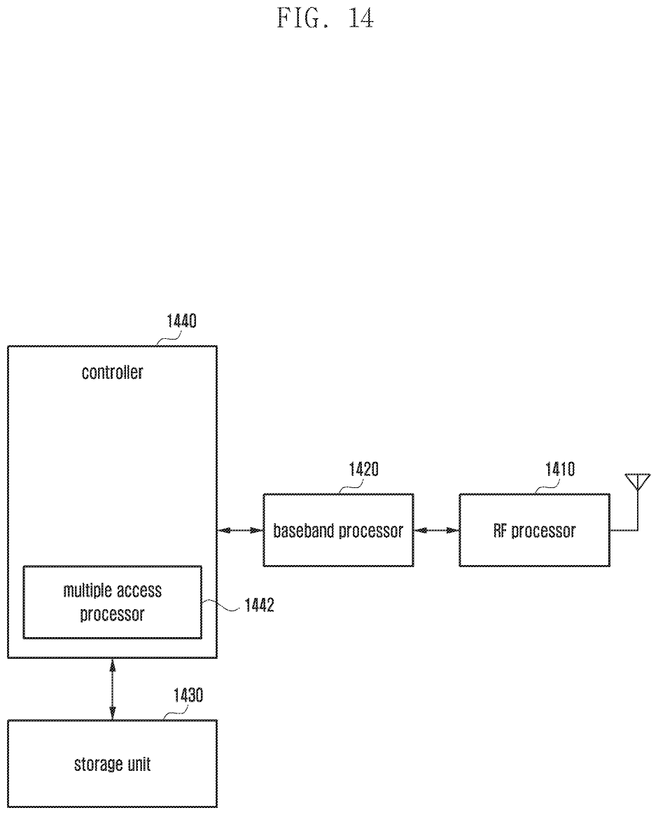

FIG. 14 is a block diagram illustrating an internal structure of a UE according to an embodiment of the disclosure.

Referring to FIG. 14, the UE includes a radio frequency (RF) processor 1410, a baseband processor 1420, a storage unit 1430, and a controller 1440.

The RF processor 1410 performs a function of transmitting or receiving a signal via a wireless channel, such as band conversion and amplification of a signal. That is, the RF processor 1410 up-converts a baseband signal provided from the baseband processor 1420 into an RF band signal, transmits the RF band signal via an antenna, and down-converts an RF band signal received via the antenna into a baseband signal. For example, the RF processor 1410 may include a transmission filter, a reception filter, an amplifier, a mixer, an oscillator, a digital-to-analog converter (DAC), an analog-to-digital Converter (ADC), and the like. Although FIG. 14 illustrates only a single antenna, the UE may include a plurality of antennas. In addition, the RF processor 1410 may include a plurality of RF chains. Moreover, the RF processor 1410 may perform beamforming. For the beamforming, the RF processor 1410 may control the phase and the size of each signal transmitted or received via a plurality of antennas or antenna elements. Also, the RF processor 1410 may perform MIMO, and may receive multiple layers when performing an MIMO operation.

The baseband processor 1420 performs a function for conversion between a baseband signal and a bitstream according to the physical layer standard of the system. For example, in the case of data transmission, the baseband processor 1420 generates complex symbols by encoding and modulating a transmission bit stream. In addition, in the case of data reception, the baseband processor 1420 restores a reception bit stream by demodulating and decoding a baseband signal provided from the RF processor 1410. For example, according to an orthogonal frequency division multiplexing (OFDM) scheme, in the case of data transmission, the baseband processor 1420 generates complex symbols by encoding and modulating a transmission bitstream, maps the complex symbols to subcarriers, and then configures OFDM symbols via an inverse fast Fourier transform (IFFT) operation and cyclic prefix (CP) insertion. Further, in the case of data reception, the baseband processor 1420 divides the baseband signal provided from the RF processor 1410 in the unit of OFDM symbols, reconstructs the signals mapped to the subcarriers via a fast Fourier transform (FFT) operation, and then reconstructs a reception bitstream via demodulation and decoding.

The baseband processor 1420 and the RF processor 1410 transmit or receive signals as described above. Accordingly, the baseband processor 1420 and the RF processor 1410 may be referred to as a transmission unit, a reception unit, a transmission/reception unit, or a communication unit. Furthermore, at least one of the baseband processor 1420 and the RF processor 1410 may include a plurality of communication modules in order to support different multiple radio access technologies. In addition, at least one of the baseband processor 1420 and the RF processor 1410 may include different communication modules to process signals of different frequency bands. For example, the different radio access technologies may include a wireless LAN (e.g., IEEE 802.11), a cellular network (e.g., LTE), and the like. Further, the different frequency bands may include a super high frequency (SHF) (e.g., 2. NRHz, NRhz) band and a millimeter (mm) wave (e.g., 60 GHz) band.

The storage unit 1430 stores data such as a basic program, an application program, configuration information, and the like for the operation of the UE. In addition, the storage unit 1430 provides data stored therein according to a request of the controller 1440.

The controller 1440 controls overall operation of the UE. For example, the controller 1440 transmits or receives a signal via the baseband processor 1420 and the RF processor 1410. In addition, the controller 1440 may record data in the storage unit 1430 and read the data. To this end, the controller 1440 may include at least one processor 1442. For example, the controller 1440 may include a communication processor (CP) that performs control for communication, and an application processor (AP) that controls an upper layer such as an application program and the like.

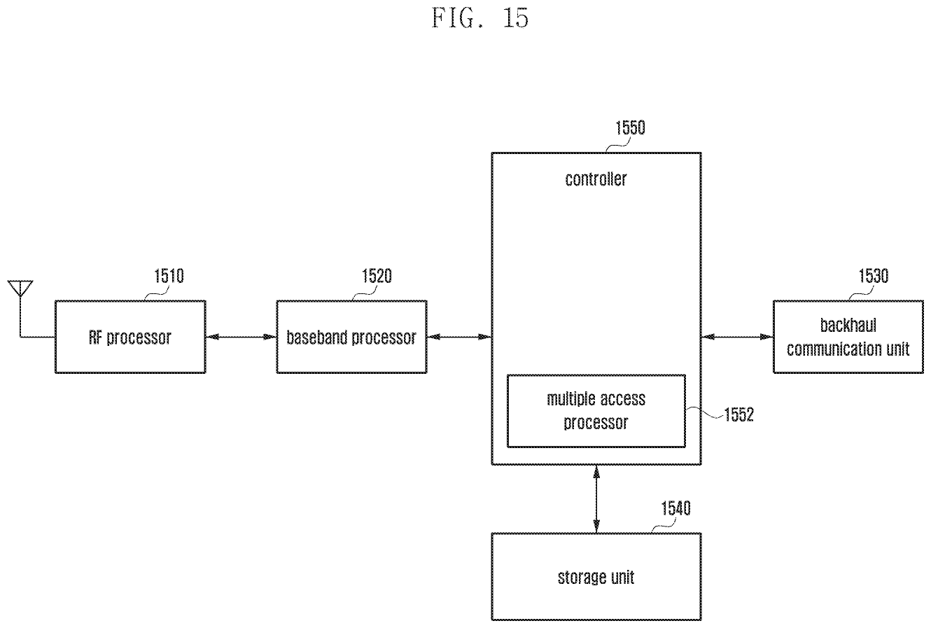

FIG. 15 is a block diagram illustrating a configuration of a base station according to an embodiment of the disclosure.

Referring to FIG. 15, a base station may include an RF processor 1510, a baseband processor 1520, a backhaul communication unit 1530, a storage unit 1540, and a controller 1550.

The RF processor 1510 performs a function for transmitting or receiving a signal via a wireless channel, such as band conversion and amplification of a signal. That is, the RF processor 1510 up-converts a baseband signal provided from the baseband processor 1520 into an RF band signal, transmits the RF band signal via an antenna, and then down-converts the RF band signal received via the antenna into a baseband signal. For example, the RF processor 1510 may include a transmission filter, a reception filter, an amplifier, a mixer, an oscillator, a DAC, an ADC, and the like. Although FIG. 15 illustrates only a single antenna, the base station may include a plurality of antennas. In addition, the RF processor 1510 may include a plurality of RF chains. Moreover, the RF processor 1510 may perform beamforming For the beamforming, the RF processor 1510 may control the phase and the size of each of the signals transmitted or received via a plurality of antennas or antenna elements. The RF processor 1510 may perform a downlink MIMO operation by transmitting one or more layers.

The baseband processor 1520 performs a function for conversion between a baseband signal and a bitstream according to the physical layer standard of a first radio access technology. For example, in the case of data transmission, the baseband processor 1520 generates complex symbols by encoding and modulating a transmission bit stream. In addition, in the case of data reception, the baseband processor 1520 restores a reception bit stream by demodulating and decoding a baseband signal provided from the RF processor 1510. For example, according to the OFDM scheme, in the case of data transmission, the baseband processor 1520 may generate complex symbols by encoding and modulating the transmission bitstream, map the complex symbols to subcarriers, and then configure OFDM symbols via an IFFT operation and CP insertion. Further, in the case of data reception, the baseband processor 1520 divides the baseband signal provided from the RF processor 1510 in the unit of OFDM symbols, reconstructs the signals mapped to the subcarriers via a FFT operation, and then reconstructs a reception bitstream via demodulation and decoding. The baseband processor 1520 and the RF processor 1510 transmit and receive signals as described above. Accordingly, the baseband processor 1520 and the RF processor 1510 may be referred to as a transmission unit, a reception unit, a transmission/reception unit, a communication unit, or a wireless communication unit.

The backhaul communication unit 1530 may provide an interface for performing the communication with other nodes in a network. That is, the backhaul communication unit 1530 may convert, into a physical signal, a bit stream transmitted from the base station to another node, for example, a secondary base station, a core network, and the like, and may convert a physical signal received from the other node into a bit stream.

The storage unit 1540 stores data such as a basic program, an application program, and configuration information for the operation of the base station. Particularly, the storage unit 1540 may store information associated with a bearer allocated to a connected UE, a measurement result reported from a connected UE, and the like. Also, the storage unit 1540 may provide multiple accesses to a UE, or may store information which is a criterion for determining whether to suspend connection. In addition, the storage unit 1540 provides data stored therein according to a request of the controller 1550.

The controller 1550 may control the overall operation of the base station. For example, the controller 1550 transmits or receives a signal via the baseband processor 1520 and the RF processor 1510, or via the backhaul communication unit 1530. In addition, the controller 1550 may record data in the storage unit 1540 and read the data. To this end, the controller 1550 may include at least one processor.

The above-described embodiments are summarized as follows.

### An Embodiment

RRC connection setup

RRC reconfiguration
DRBtoAddMod
   PDCP discard timer
   . . .
DRX configuration
   Short DRX cycle, long DRX cycle,
scheduling request configuration

Downlink/uplink data transfer with DRX operation
normal scheduling for uplink traffic
   immediately triggering R-BSR and SR if uplink traffic is incurred and Regular BSR requirement is satisfied
   If UL traffic is incurred, PDCP module immediately reports the same to lower layer.
Normal scheduling for downlink traffic
   If BS receives DL packet, BS performs data transmission as quickly as possible at the point in time at which DL packet transmission is allowed.

The necessity of power saving arises.

UE->BS: transmitting delay report via RRC or MAC CE
delay report
   DL tolerable delay per DRB (or per QoS Flow)
      a time in which BS scheduler is allowed to perform buffering before transmitting DL traffic in order to maximize DL traffic aggregation
   UL applied buffering delay per DRB (or per QoS Flow)
      a waiting time until UE triggers scheduling request in order to maximize UL traffic aggregation

BS<-UE: Confirmation

Downlink/uplink data transfer with DRX operation
Delayed scheduling for uplink traffic
   triggering R-BSR and SR after UL applied buffering delay elapses even though uplink traffic is incurred and Regular BSR requirement is satisfied
   PDCP module drives UL applied buffering delay timer when UL traffic is incurred. If the timer expires, the occurrence of data is reported to lower layer.
Delayed scheduling for downlink traffic
   If BS receives DL packet, transmitting data at the point in time closest to DL tolerable delay
   operating timer (a value less than a DL tolerable delay) when DL packet is received. If timer expires, starting scheduling associated with corresponding QoS flow

### Second Embodiment

RRC connection establishment
RRC connection reconfiguration
DRBtoAddMod
whether Target State Indication is configured
Data transfer on DRBs
performing following operations if Target State Indication is configured
UE: expects that data transmission or reception via currently configured DRB is not performed any longer, or recognizes that previously reported target state is changed●UE: determines target transition state
   In case 1, target state=IDLE
      the point in time at which subsequent traffic is expected to be incurred is greater than or equal to xxx msec, and
      the current movement speed of UE is less than or equal to yy km/h
   In case 2, target state=INACTIVE
      the point in time at which subsequent traffic is expected to be incurred is less than or equal to xxx msec, or
      the current movement speed of UE is greater than or equal to yy km/h
UE: determines target transition state Target State Indication RRC message
   Target State =IDLE or INACTIVE
      OtherRecommendation
         paging cycle
         RNA area size (single cell or not)

UE<-GNB: RRCRelease

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
identifying a preferred state of the terminal;
transmitting, to a base station, a first message comprising information on the preferred state of the terminal; and
receiving, from the base station, a second message for transitioning a state of the terminal as a response to the first message.

2. The method of claim 1, wherein the transmitting of the first message comprises:
receiving, from the base station, configuration information indicating whether the terminal is configured to transmit the information on the preferred state of the terminal to the base station; and
transmitting, to the base station, the first message comprising the information on the preferred state of the terminal, in case that the terminal is configured to transmit the information on the preferred state of the terminal to the base station.

3. The method of claim 1, wherein the first message comprises a user equipment (UE) assistance information message.

4. The method of claim 1, wherein the preferred state comprises at least one of an idle state or an inactive state.

5. The method of claim 1, wherein the first message including the information on the preferred state of the terminal is transmitted in case that the terminal does not expect to transmit or receive data within a predetermined time.

6. A method performed by a base station in a wireless communication system, the method comprising:
receiving, from a terminal, a first message comprising information on a preferred state of the terminal; and
transmitting, to the terminal, a second message for transitioning a state of the terminal as a response to the first message.

7. The method of claim 6, wherein the receiving of the first message comprises:
transmitting, to the terminal, configuration information indicating whether the terminal is configured to transmit the information on the preferred state of the terminal to the base station; and
receiving, from the terminal, the first message comprising the information on the preferred state of the terminal, in case that the terminal is configured to transmit the information on the preferred state of the terminal to the base station.

8. The method of claim 6, wherein the first message comprises a user equipment (UE) assistance information message.

9. The method of claim 6, wherein the preferred state comprises at least one of an idle state or an inactive state.

10. The method of claim 6, wherein the first message including the information on the preferred state of the terminal is received in case that the terminal does not expect to transmit or receive data within a predetermined time.

11. A terminal in a wireless communication system, the terminal comprising:
a transceiver; and
a controller configured to:
identify a preferred state of the terminal,
transmit, to a base station via the transceiver, a first message comprising information on the preferred state of the terminal, and
receive, from the base station via the transceiver, a second message for transitioning a state of the terminal as a response to the first message.

12. The terminal of claim 11, wherein the controller is further configured to:
receive, from the base station via the transceiver, configuration information indicating whether the terminal is configured to transmit the information on the preferred state of the terminal to the base station, and
transmit, to the base station via the transceiver, the first message comprising the information on the preferred state of the terminal, in case that the terminal is configured to transmit the information on the preferred state of the terminal to the base station.

13. The terminal of claim 11, wherein the first message comprises a user equipment (UE) assistance information message.

14. The terminal of claim 11, wherein the preferred state includes at least one of an idle state or an inactive state.

15. The terminal of claim 11, wherein the first message including the information on the preferred state of the terminal is transmitted in case that the terminal does not expect to transmit or receive data within a predetermined time.

16. A base station in a wireless communication system, the base station comprising:
a transceiver; and
a controller configured to:
receive, from a terminal via the transceiver, a first message comprising information on a preferred state of the terminal, and
transmit, to the terminal via the transceiver, a second message for transitioning a state of the terminal as a response to the first message.

17. The base station of claim 16, wherein the controller is further configured to:
transmit, to the terminal via the transceiver, configuration information indicating whether the terminal is configured to transmit the information on the preferred state of the terminal to the base station, and
receive, from the terminal via the transceiver, the first message comprising the information on the preferred state of the terminal, in case that the terminal is configured to transmit the information on the preferred state of the terminal to the base station.

18. The base station of claim 16, wherein the first message comprises a user equipment (UE) assistance information message.

19. The base station of claim 16, wherein the preferred state comprises at least one of an idle state or an inactive state.

20. The base station of claim 16, wherein the first message including the information on the preferred state of the terminal is received in case that the terminal does not expect to transmit or receive data within a predetermined time.
